(19) United States
(12) Patent Application Publication
(10) Pub. No.: US 2025/0066679 A1
(43) Pub. Date: Feb. 27, 2025

(54) SYSTEMS, METHODS, AND DEVICES FOR PROCESSING CRUDE OIL

(71) Applicant: Enertech Holding Company KSCC, Kuwait City (KW)

(72) Inventor: Mohammed FUAD BANI SALAMEH, Kuwait City (KW)

(73) Assignee: Enertech Holding Company KSCC, Kuwait City (KW)

(21) Appl. No.: 18/723,786

(22) PCT Filed: Dec. 23, 2022
(86) PCT No.: PCT/US2022/053954

§ 371 Date: Jun. 24, 2024

Related U.S. Application Data
(60) Provisional application No. 63/293,213, filed on Dec. 23, 2021.

(51) Int. Cl. C10G 33/06; B01D 17/02; B01D 19/00; B01D 21/26; C02F 1/20; C02F 1/38; C02F 1/40; C02F 11/125; C02F 101/32

(52) U.S. Cl. CPC C10G 33/06; B01D 17/0217; B01D 19/0052; B01D 21/262; C02F 1/20; C02F 1/385; C02F 1/40; C02F 11/125; C02F 2101/32; C10G 2300/1037

(57) ABSTRACT

The present disclosure relates to novel and advantageous systems, methods, and devices for processing crude oil. Particularly, the present disclosure relates to novel and advantageous systems, methods, and devices for separating crude oil into components. More particularly, the present disclosure relates to novel and advantageous systems, methods, and devices for separating crude oil into components of different densities.

### FIELD OF THE INVENTION

The present disclosure relates to novel and advantageous systems, methods, and devices for processing crude oil. Particularly, the present disclosure relates to novel and advantageous systems, methods, and devices for separating crude oil into components. More particularly, the present disclosure relates to novel and advantageous systems, methods, and devices for separating crude oil into components of different densities.

### BACKGROUND OF THE INVENTION

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Crude oil is a finite resource. It can be processed to separate various components into separate usable components, commonly done using fractional distillation. Some of these components undergo cracking to help meet demand for smaller molecules.

Fractional distillation uses a fractionating tower that separates the crude oil into simpler, more useful components. One such component is hydrocarbon molecules. Hydrocarbon molecules generally have similar boiling points and thus can be separated together in fractional distillation.

FIG. 1a illustrates a basic prior art fractionating tower 1 for separating crude oil into component parts. As shown, the fractionating tower is hotter at a lower portion 3 thereof and cooler at an upper portion 5 thereof. A plurality of pipes 7 are provided at levels of the fractionating tower 1 corresponding to elevations at which particular components may be removed.

During the fractional distillation of crude oil, heated crude oil enters a fractionating column or tower, which is hot at the bottom and increasingly cool towards the top. Vapors from the crude oil rise through the column. Vapors condense when they become cool enough-which is at different temperatures for various components based on their boiling points. Liquids are thus led out of the column at different heights generally corresponding to the height at which the temperature of the column falls below the respective boiling point. The shortest hydrocarbons, having very low boiling points, do not condense and leave the column in the gas state.

FIG. 1b illustrates an overview sketch of a prior art fractionating tower 1 showing crude oil components 9 and their uses. This adopted process in crude oil treatment, in its raw production stage, is a physio-chemical separation process where crude oil is exposed to soft physical effects in addition to chemical and associated thermodynamic processes. A purely mechanical process has been thought to be not sufficiently strong because it may not exceed the limit of agitation, which is a precipitation of gravity. Thus, physical processes are considered to result in an inefficient cyclical effect.

Centrifuged water and crude oil forms a highly viscous non-Newtonian fluid mixture having a viscosity exceeding 0.8 Pa·sec or 0.8 kg/m·sec. This is significantly affected by a shear thickening phenomenon, where shear stress exponentially rises with any velocity gradient effect. Current centrifugal processes for separating crude oil do not sufficiently account for the non-Newtonian fluid mixture and thus have limited success. The cohesive forces between adjacent liquid layers and adhesive forces between liquid and machine stationary surfaces, which may be referred to as the liquid physical response, almost eliminate the useful retarding centrifugal force resulting in the failure of oil dehydration. FIG. 1c illustrates the shear thickening phenomenon.

Thus, there is a need in the art for mechanical process for separating crude oil into components that overcomes the challenges of shear thickening of non-Newtonian fluids.

### BRIEF SUMMARY OF THE INVENTION

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

An apparatus for processing crude oil is provided. The apparatus includes a rotatable assembly and a drive to rotate the rotatable assembly. The rotatable assembly may comprise a rotatable vessel, a crude oil inlet, a crude oil processing chamber, a water outlet, and a crude oil outlet. The rotatable assembly may have an outer wall and may surround a volume. The crude oil inlet may be configured to accept crude oil into the vessel. The crude oil processing chamber may be configured to contain a volume of crude oil and may be in fluid communication with the crude oil inlet. The water outlet may be in fluid communication with the crude oil processing chamber. The water outlet may be located proximate a radially outward region of the crude oil processing chamber and may be configured to direct water out of the crude oil processing chamber after the water has been separated from the crude oil. The crude oil outlet may be in fluid communication with the crude oil processing chamber located at a radially inward location relative to the water outlet. The drive apparatus may be configured to rotate the rotatable assembly about an axis of rotation, wherein during operation of the apparatus: the drive causes the rotatable assembly to rotate about the axis of rotation and crude oil in the crude oil processing chamber is caused to rotate with the rotatable assembly, causing the crude oil to separate into components of different densities, causing water to migrate toward the water outlet and oil to migrate toward the oil outlet. The apparatus for processing crude oil may be configured to operate to continuously separate components of crude oil. The apparatus for processing crude oil may further include a flywheel mechanically coupled to the rotatable assembly to facilitate continuous rotation of the rotatable assembly.

In some embodiments, the rotatable vessel is generally cylindrical in shape, and the crude oil processing chamber is generally annular in shape, and, during operation, the crude oil separates into a radially outer annular water volume, and a radially inner oil volume. In some embodiments, the axis of rotation is vertically oriented, and the rotatable assembly includes at least one solids discharge port, the at least one solids discharge port being located proximal a radially outward location of the rotatable vessel proximate a bottom end of the crude oil processing chamber, wherein rotation of the rotatable assembly causes solid particulate suspended within the crude oil to migrate radially outwardly and gravity pulls the solid particulate downwardly toward the at least one solids discharge port. The crude oil processing chamber may be located in a lower portion of the rotatable vessel, and the rotatable vessel may further include a water reservoir located above the crude oil processing chamber to receive water separated in the crude oil processing chamber, wherein the water outlet is coupled to an inlet of the water reservoir by way of at least one conduit. The water reservoir may be annularly shaped.

In some embodiments water is advanced through the at least one conduit due to pressure exerted on the contents of the crude oil processing chamber. The water reservoir may include at least one water outlet located in a radially inward region of the rotatable vessel. The at least one water outlet of the water reservoir may be located radially outwardly with respect to the crude oil outlet of the crude oil processing chamber. The rotatable vessel may further include a vertically disposed gas evacuation plenum located in a central region of the rotatable vessel such that a radially outwardly facing surface of the gas evacuation plenum forms an inner surface of the crude oil processing chamber, and gas phases separated from the crude oil are transported upwardly through the vertically disposed gas plenum and out of the apparatus.

The apparatus for crude oil processing may further comprise an oil-gas mechanical seal disposed an upper end of the apparatus, the oil-gas mechanical seal having an interior chamber in fluid communication with an upper end of the vertically disposed gas evacuation plenum. The vertically disposed gas evacuation plenum directs gases extracted from crude oil into a chamber of the oil-gas mechanical seal, wherein the chamber of the oil-gas mechanical seal is coupled to at least one gas exit port to transport gases out of the apparatus. The chamber of the oil-gas mechanical seal may be bounded by a peripheral wall, an upper wall and a lower wall. The upper wall and lower wall of the oil-gas mechanical seal may each be bounded by a liquid reservoir to address gas leakage from the chamber of the oil-gas mechanical seal. The liquid reservoir may comprises NaOH, wherein the gas is H₂S, and wherein the liquid reservoir addresses gas leakage by reacting with the gas to generate Na₂S. The oil-gas mechanical seal may be stationary with respect to the rotating assembly. The oil-gas mechanical seal may receive an upper portion of the rotating assembly therein that includes the upper end of the vertically disposed gas evacuation plenum. The oil-gas mechanical seal may include a plurality of seals that seal against the upper end of the vertically disposed gas evacuation plenum. The oil-gas mechanical seal may include a plurality of seals that seal against the upper end of the vertically disposed gas evacuation plenum.

In some embodiments, the at least one solids discharge port may be configured to direct a slurry of material including solids into a strainer to further separate the solids from liquid components of the slurry. The strainer may include an elongate outer vessel and an elongate porous inner vessel disposed within the elongate outer vessel, the elongate porous inner vessel having a motorized screw auger disposed therein, the strainer further having a slurry inlet to direct slurry into the elongate inner vessel, a solids outlet in mechanical communication with the elongate inner vessel, and a liquid outlet in communication with the outer vessel, wherein the slurry inlet directs slurry into the elongate inner vessel wherein the screw auger advances the slurry toward the solids outlet, and further wherein liquid is transported from the slurry and into a chamber defined between the elongate outer vessel and the elongate porous inner vessel to separate liquid from the solids in the slurry. The strainer may be inclined at an angle to cause the screw auger to advance the solids upwardly as the solids are separated from the liquid of the slurry.

In some embodiments, the apparatus for processing crude oil further comprises a suspended solids discharging valve in fluid communication with the at least one solids discharge port, the suspended solids discharge valve being located at least partially underneath the crude oil processing chamber. The suspended solids discharging valve may include a sampling disc that defines at least one solids evacuation conduit formed therein, the sampling disc being configured to rotate relative to a lower wall of the crude oil processing chamber. The lower wall of the crude oil processing chamber may define at least one opening therethrough, and relative rotation of the sampling disc with respect to the lower wall of the crude oil processing chamber causes the at least one opening in the lower wall of the crude oil processing chamber to align with the at least one solids evacuation conduit of the sampling disc for a predetermined period of time to cause solids to be transported from the crude oil processing chamber, through the at least one opening in the lower wall of the crude oil processing chamber, and into the at least one solids evacuation conduit of the sampling disc. The suspended solids discharging valve may further include a discharge ring including at least one radially outwardly facing discharge port, wherein solids are conveyed by the sampling disc to the at least one radially outwardly facing discharge port.

The sampling disc may be caused to rotate relative to the lower wall of the crude oil processing chamber by a gear train driven by a second drive. The gear train may be a planetary gear train.

The rotating assembly may be configured to rotate at a first speed and the sampling disc may configured to rotate at a second speed different from the first speed in order to permit relative rotation of the sampling disc to the crude oil processing chamber. The first speed may be within about one percent of the second speed. The first speed and the second speed may differ by between about one revolution per minute and about ten revolutions per minute. The first speed may be between about 500 revolutions per minute and about 5000 revolutions per minute.

A method of purifying crude oil is provided. The method includes directing a stream of crude oil into a rotating chamber of a separation device, causing the crude oil to rotate with the rotating chamber of the separation device to cause the crude oil to separate into component parts, and causing the component parts to exit the separation device. Causing the crude oil to rotate with the separation device causes the crude oil to stratify along a radial direction into a gaseous component, a purified oil component, a water component, and a solids component. The gaseous component is evacuated through a gas evacuation tube in a central region of the separation device. The purified oil caused to exit through an oil exit port located radially outwardly from the gas evacuation tube. The water component is caused to exit through a water exit port located radially outwardly with respect to the oil exit port. The method may further comprise continuously operating the separation device and continuously introducing crude oil into the separation device and continuously evacuating oil and water from the separation device.

The solids component may be evacuated through a solids evacuation port of the separation device. The solids component may be directed in a slurry form into a solids separation strainer. The gaseous component may be directed into a stationary chamber of an oil-gas mechanical seal located at an upper end of the separation device, the oil-gas mechanical seal including a plurality of mechanical seals that rotatably receive the upper end of the separation device. The oil-gas separation device may include liquid reservoirs located above and below the stationary chamber, wherein gas that leaks past the plurality of mechanical seals is intercepted and neutralized by the liquid reservoirs. Gas that leaks past the plurality of mechanical seals may be is intercepted by the liquid reservoirs includes hydrogen sulfide.

A device to neutralize harmful gases is provided. The device may comprise a vessel having a gas receiving chamber and liquid filled reservoirs. The gas receiving chamber may be coupled to a gas inlet and a gas outlet, the gas receiving chamber being configured to rotatably receive a rotating tubular conduit directing a gas flow. The liquid filled reservoirs may be disposed above and below the gas receiving chamber to receive gas leaking past seals of the gas receiving chamber. The receiving chamber may comprise a plurality of cascading chambers separated by mechanical seals. The four cascading chambers may be provided separated by four mechanical seals.

An oil-gas mechanical seal is provided. The seal may be stationary and may comprise an interior chamber and a gas entrance port for allowing gas into the interior chamber. The interior chamber may be bounded by a peripheral wall, an upper wall, and a lower wall. The gas entrance port may be in fluid communication with a gas evacuation plenum from a separator apparatus wherein the separator apparatus has a gas exit port to transport gases out of the apparatus to the gas evacuation plenum. The upper and lower wall may be bounded by a liquid reservoir that addresses gas leakage from the chamber. In one embodiment, the gas is H₂S and the liquid reservoir is NaOH, and the liquid reservoir addresses gas leakage by reacting with the H₂S to form Na₂S.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE DRAWINGS

While the specification concludes with claims particularly pointing out and distinctly claiming the subject matter that is regarded as forming the various embodiments of the present disclosure, it is believed that the invention will be better understood from the following description taken in conjunction with the accompanying Figures, in which:

FIG. 1a is a prior art prior art fractionating tower for separating crude oil into component parts.

FIG. 1b is a prior art fractionating tower showing crude oil components and their uses.

FIG. 1c illustrates a shear thickening phenomenon.

FIG. 2a illustrates a cross sectional side view of a crude oil separator, in accordance with one embodiment.

FIG. 2b illustrates an operating discharging nozzle design of the crude oil separator of FIG. 2a, in accordance with one embodiment.

FIG. 2c illustrates a cross sectional perspective view of the crude oil separator of FIG. 2a.

FIG. 2d illustrates a photograph of the exterior of a crude oil separator, in accordance with one embodiment.

FIG. 3a illustrates weight of spinning liquid shell under the influence of a rad/s.

FIG. 3b illustrates a general separation profile for the rotatable vessel, in accordance with one embodiment.

FIG. 3c illustrates the rotatable vessel, including the separation profile of FIG. 3b, liquid sensors, the water outlet, the crude oil outlet, and the gas outlet, in accordance with one embodiment.

FIG. 3d illustrates the rotatable vessel, including the separation profile of FIG. 3b, and specificity of the water outlet, the crude oil outlet, and the gas outlet, in accordance with one embodiment.

FIG. 4a illustrates a drive gear mechanism, in accordance with one embodiment.

FIG. 5 illustrates a gas-oil mechanical seal, in accordance with one embodiment.

FIG. 6a illustrates a particulate discharger, in accordance with one embodiment.

FIG. 6b illustrates photographs of a particulate discharger, in accordance with one embodiment.

FIG. 6c illustrates an isometric view of a cascaded rotary gear, in accordance with one embodiment.

FIG. 7 illustrates a slurry separator, in accordance with one embodiment.

FIG. 8a illustrates a process flow diagram, in accordance with one embodiment.

FIG. 8b illustrates velocity drop under gravitational separation and

velocity drop under centrifugal separation.

FIG. 8c illustrates the net effective pushing separation forces affecting unwanted impurities, in accordance with the Archimedes principle.

FIG. 9a illustrates the effect of acceleration ranges on water.

FIG. 9b illustrates the effect of acceleration ranges on water droplets separation speed, respectively.

FIG. 10a illustrates the effects of acceleration ranges on sand.

FIG. 10b illustrates the effects of acceleration ranges on marble and

solids.

FIG. 10c illustrates the effects of acceleration ranges on limestone.

FIG. 11 illustrates sand separation speed in cm/s as a function of frequency, impurity radius, and media viscosity.

FIG. 12 illustrates the effect of acceleration on metals.

FIG. 13 illustrates metals separation speed in cm/s as a function of frequency, impurity radius, and media viscosity.

FIG. 14 illustrates separation solidarity using the crude oil separation system.

FIG. 15a illustrates the effects of acceleration ranges on salt.

FIG. 15b illustrates salt separation speed in cm/s as a function of frequency, impurity radius, and media viscosity.

FIG. 16 illustrates de-sludging, de-salting, and de-gassing profiles.

FIG. 17a illustrates the acceleration ranges in terms of 1000 gravity effect.

FIG. 17b illustrates the effect of acceleration ranges in flashing gases.

FIG. 18 illustrates gases flashing speed in cm/s as a function of frequency, bubble radius, and media viscosity.

FIG. 19 illustrates a three-dimensional frequency performance chart.

FIG. 20 illustrates the net effective pushing separation forces affecting unwanted impurities.

FIG. 21 illustrates the efficient separation force in terms of gravity.

FIG. 22 illustrates the three dimensional efficient centrifugal force in terms of gravity.

FIG. 23 illustrates the process of crude oil de-hydration.

FIG. 24 illustrates the sediment de-assembling process.

FIG. 25 illustrates an operating case study.

### DETAILED DESCRIPTION

The present disclosure relates to novel and advantageous systems, methods, and devices for processing crude oil. Particularly, the present disclosure relates to novel and advantageous systems, methods, and devices for separating crude oil into components. More particularly, the present disclosure relates to novel and advantageous systems, methods, and devices for separating crude oil into components of different densities.

Broadly speaking, the present disclosure relates to a crude oil purifier. The system, method, device, and apparatus provide an effective main purification process that may include crude oil de-hydration, sludge sediment de-assembling, total suspended solids (TSS) separation, crude oil de-salting, TSS scrubbing, and de-gassing. It is to be appreciated that, as used herein, crude oil includes oil, water, impurities, particles, gas, etc.

The present disclosure adopts a retarding centrifugal force effect to perform roles in different areas of separation techniques. A centrifugal separator, also referred to as a hydroclone, a motor driven hydroclone, and more generally a rotatable assembly, operates to perform a de-hydration process on the crude oil. The crude oil separator herein disclosed is able to separate viscous fluids without shear thickening of the non-Newtonian fluid mixture and impurities.

The crude oil processor has many advantages over prior art crude oil processors. These include:
TSS values can be significantly reduced, for example down to 35 ppm;
Water cut percentages may be reduced to a minimal level;
Separated suspended solids volume may be significantly reduced, for example to a few microns;
The separator can overcome all or most main media viscosity. Stocks and abeyant forces generally cannot resist the efficient retarding force;
Sludge sediment structure is practically de-assembled and resultant oil is lighter;
Efficiently de-salts heavy crude oil such that the separated oil is generally desalted and required water for desalting is minimized;
De-gases such that the separated oil is super sweetened;
The separator has a tunable performance efficiency;
Production capacity may be expanded while keeping power consumption in a selected range; generally a power saving machine;
May be self-cleaning and filter cartridge free;
Can meet Health, Safety, and Environment regulations;
Includes a periodically or selective pneumatically operated discharging system-spinning valve; and
The separator may be a liquid classifier with liquid distinguishing sensors.

The crude oil processor or separator may have indirect positive technical results of oil de-hydration in addition to the simplification of the separation process. Water needed for de-salting is significantly decreased. Chemical catalysts needed for processing are lowered. Heating of the oil-water blend for de-hydration is not needed. The time of the oil in the de-salter is decreased and unit productivity is thus increased. This has been shown to achieve a 30% increase in production capacity. Pipe and fitting deterioration is minimal. Maintenance needs and periodic blockage are lowered due to the reduction in sludge sediment. Standstill environmental impacts stemming from dumping areas are controlled after sludge elimination. Precipitated sludge in main storage vessels is lowered.

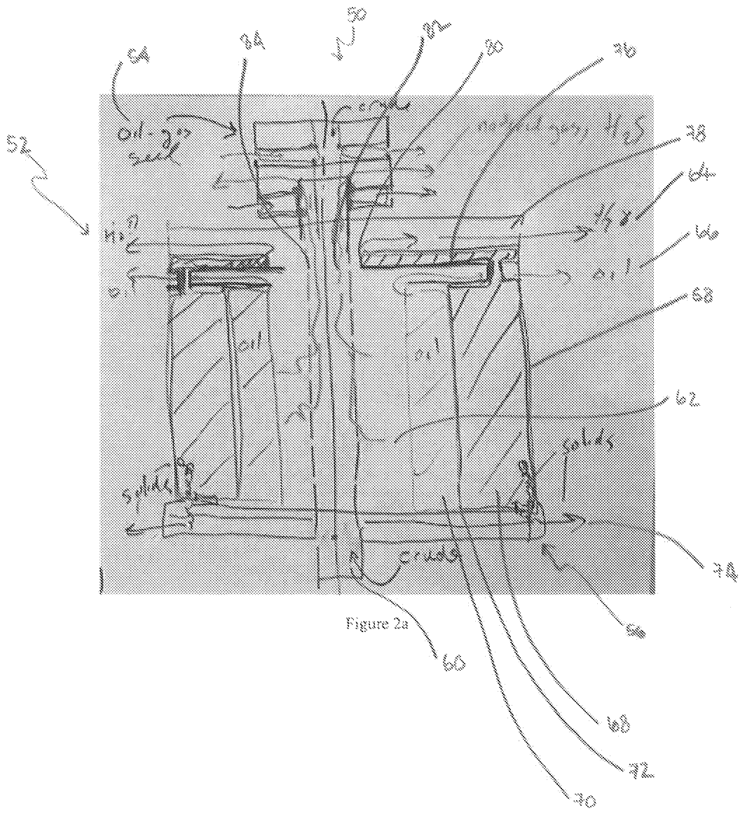

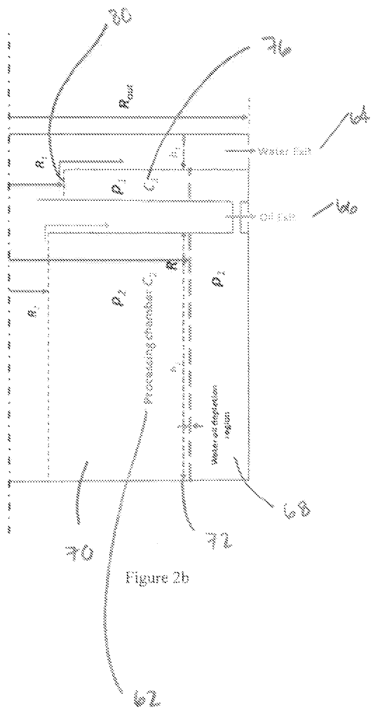

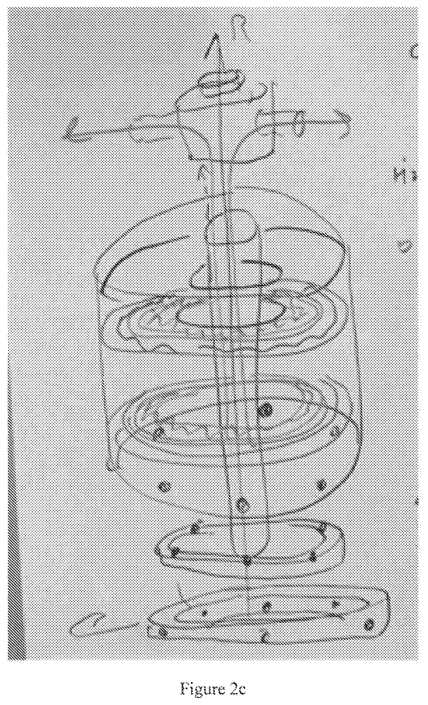

FIG. 2a illustrates a cross sectional side view of a crude oil separator, in accordance with one embodiment. FIG. 2b illustrates an operating discharging nozzle design of the crude oil separator of FIG. 2a, in accordance with one embodiment. FIG. 2c illustrates a cross sectional perspective view of the crude oil separator of FIG. 2a. FIG. 2d illustrates a photograph of the exterior of a crude oil separator, in accordance with one embodiment. In various embodiments, the crude oil separator, or portions thereof, may comprise food grade thermally treated stainless steel such that the separator may be self-cleaning.

As shown, the crude oil separator 50 comprises a rotatable assembly 52, an oil-gas seal 54, and a particulate discharger 56 (shown exploded in FIG. 2c). The oil-gas seal 54 may be provided over the rotatable assembly 52 and the particulate discharger 56 may be provided under the rotatable assembly 52. The rotatable assembly 52 comprises a centrifugal mechanism that may rotate continuously during operation. The rotatable assembly includes a rotatable vessel 58, a crude oil inlet 60, a crude oil processing chamber 62, one or more water outlets, and one or more crude oil outlets. The rotatable vessel 58 has an outer wall and surrounds the crude oil processing chamber 62. The crude oil inlet 60 accepts crude oil into the vessel 58. The crude oil processing chamber 62 is configured to contain a volume of crude oil and is in fluid communication with the crude oil inlet 60. The water outlet(s) 64 is in fluid communication with the crude oil processing chamber and is located proximate a radially outward region 68 of the crude oil processing chamber 62. The water outlet(s) 64 is configured to direct water out of the crude oil processing chamber 62 after the water has been separated from the crude oil. The crude oil outlet 66 is in fluid communication with the crude oil processing chamber 62 and is located proximate a radially inward region 70 of the crude oil processing chamber 62. The crude oil outlet 66 is located at a radially inward location relative to the water outlet 64. The drive rotates the rotatable assembly 52 about an axis of rotation. The axis of rotation may be vertically oriented. During operation of the apparatus, the drive causes the rotatable assembly 52 to rotate about the axis of rotation. The crude oil in the crude oil processing chamber rotates with the rotatable assembly, causing the crude oil to separate into components of different densities. Water migrates generally outwardly and within the radially outward region 68 while oil migrates generally inwardly of the water and within the radially inward region 70. Water thus migrates towards the water outlet 64 and oil migrates toward the oil outlet 66. It is noted that the terms water and brine water are used interchangeably herein.

The crude oil separator may be configured to operate to continuously separate components of crude oil and, more specifically, to continuously separate components of crude oil based on their density. In some embodiments, a flywheel may be mechanically coupled to the rotatable assembly to facilitate continuous rotation of the rotatable assembly

The rotatable vessel 58 may be generally cylindrical in shape with the crude oil processing chamber 62 being generally annular in shape. During operation, the crude oil separates into a radially outer annular water volume 68, and a radially inner annular oil volume 70. A natural separation barrier 72 may be present between the annular water volume 68 and the annular oil volume 70. Sensors may be provided to measure the separation barrier and ensure that it is properly aligned to direct the oil to the crude oil outlet 66 and the water to the water outlet 64.

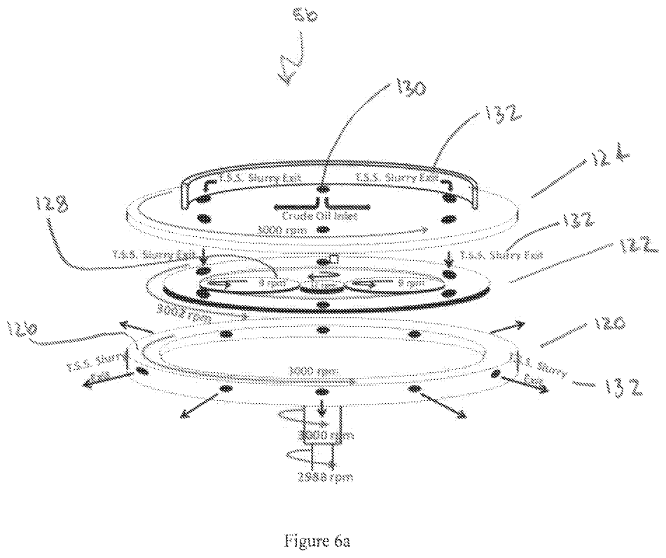

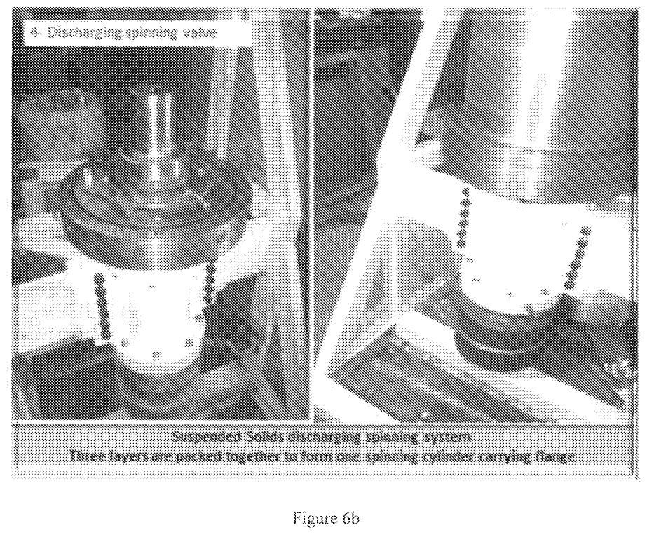

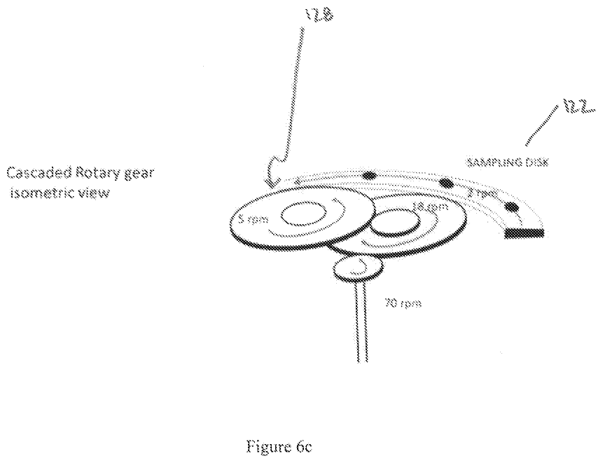

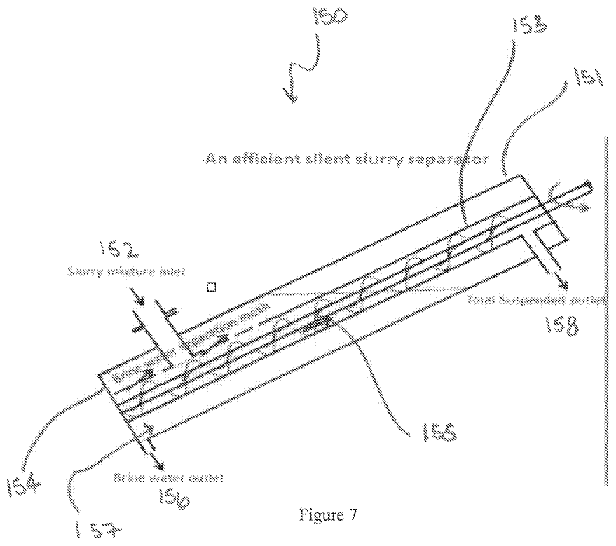

The rotatable assembly 52 may include at least one solids discharge port 74, the at least one solids discharge port 74 being located proximal a radially outward location of the rotatable vessel 58 proximate a bottom end of the crude oil processing chamber 62. Rotation of the rotatable assembly 52 may cause solid particulate suspended within the crude oil to migrate radially outwardly with gravity pulling the solid particulate downwardly toward the at least one solids discharge port 74. The at least one solids discharge port 72 may be configured to direct a slurry of material including solids into a strainer (see FIG. 7) to further separate the solids from liquid components of the slurry.

A suspended solids discharging valve 56, also referred to as particulate discharger, may be provided in fluid communication with the at least one solids discharge port 74, the suspended solids discharge valve 56 being located at least partially underneath the crude oil processing chamber 62.

The crude oil processing chamber 62 may be located in a lower portion of the rotatable vessel 58. The rotatable vessel 58 may include a water reservoir 76 located above the crude oil processing chamber to receive water separated in the crude oil processing chamber. The water reservoir 76 may be annularly shaped. The water outlet 64 may be coupled to an inlet of the water reservoir by way of at least one conduit 78. Water may be advanced through the at least one conduit 78 due to pressure exerted on the contents of the crude oil processing chamber 62. The water reservoir 76 may include at least one water outlet 80 and the at least one water outlet 80 of the water reservoir 76 may be located in a radially inward region of the rotatable vessel 58. The at least one water outlet of the water reservoir may be located radially outwardly with respect to the crude oil outlet of the crude oil processing chamber.

The rotatable vessel 58 may include a vertically disposed gas evacuation plenum 82 located in a central region of the rotatable vessel. A radially outwardly facing surface 84 of the gas evacuation plenum 82 may form an inner surface of the crude oil processing chamber. Gas phases separated from the crude oil may be transported upwardly through the vertically disposed gas plenum 82 and out of the apparatus.

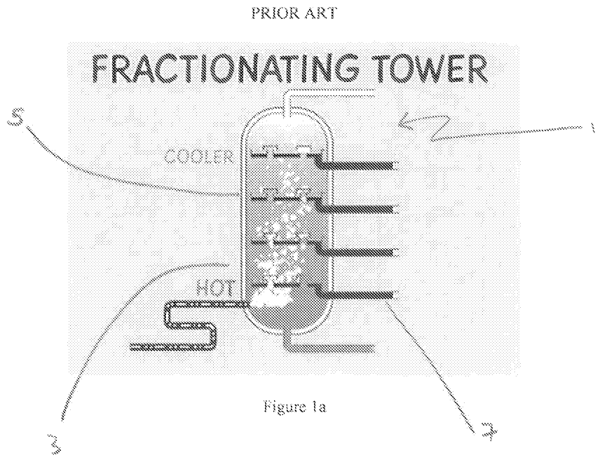

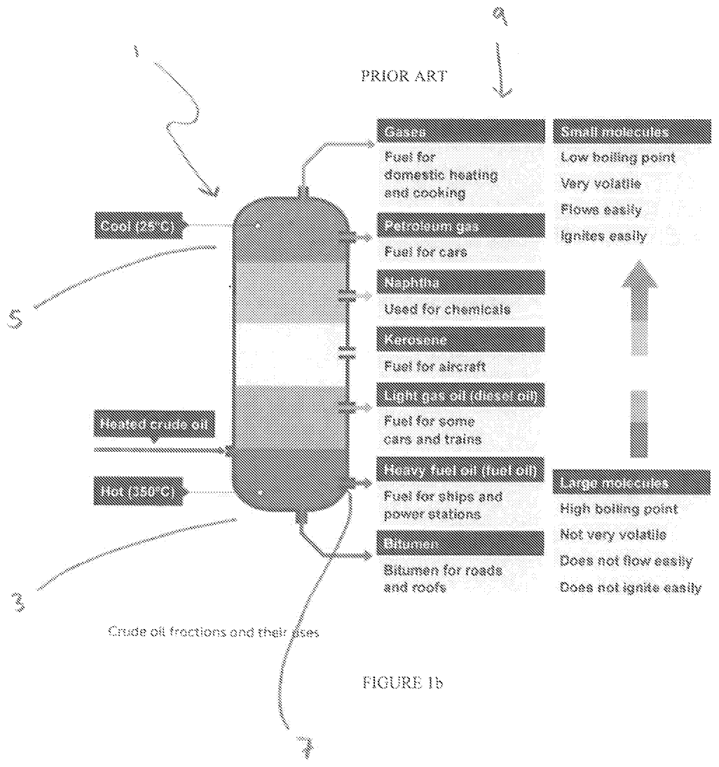

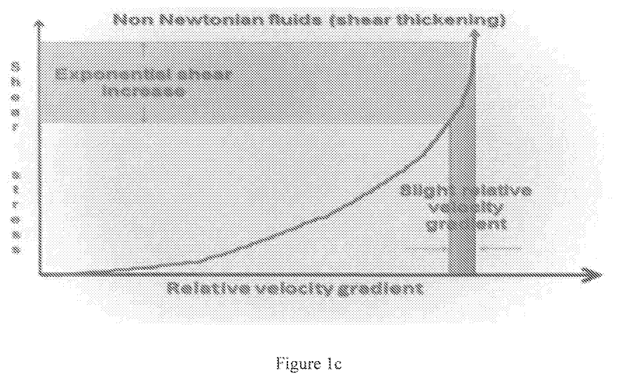

The rotatable vessel 58 is tunable and eliminates or reduces the shear thickening phenomena leading to non-Newtonian fluids. Referring again to FIG. 1c, a reason for the failure of centrifugal separation in high viscous fluids higher than that of water (of a viscosity that may exceeds 1.0 Pa·sec) is that water and crude oil are a non-Newtonian fluid mixture that is greatly affected by shear thickening phenomena where shear stress exponentially rises with any velocity gradient effect. This stems from an inadequate interactive design between stationery and dynamic parts of these machines. The liquid physical response (cohesive forces between adjacent liquid layers and adhesive forces between liquid and machine stationery surfaces) almost eliminates the useful retarding centrifugal force. This is a primary reason for failure in oil dehydration when motor driven hydro-clones or ordinary hydro-clones are used. The disclosed rotatable vessel eliminates this failure.

Using the crude oil separator herein described, fluids inside the spinning cylinder move at the same speed as the rotatable vessel. As a result, there is no relative speed between the fluids and the rotatable cylinder. Because the relative velocity gradient is kept zero, there is zero shear stress. This keeps the non-Newtonian fluid thin and substantially prevents fluid thickening, which is the primary failure point for centrifugal separation discussed above.

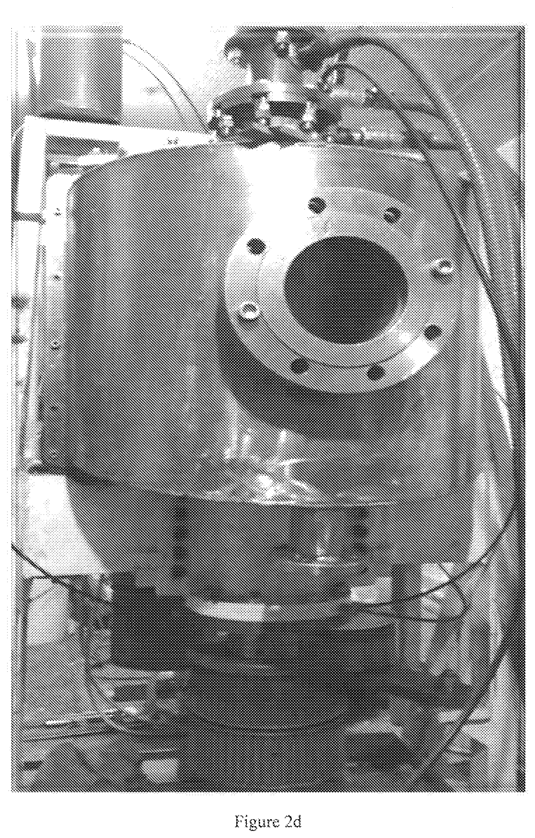

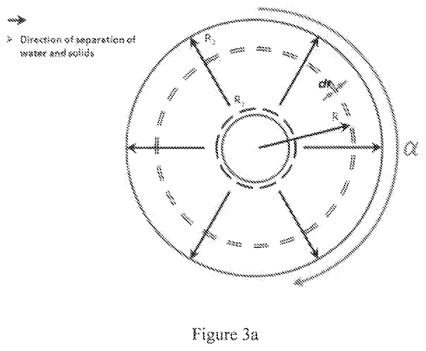

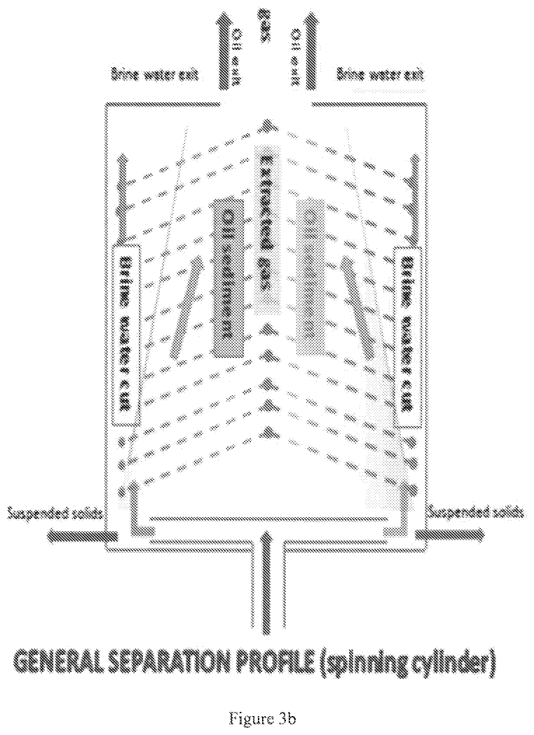

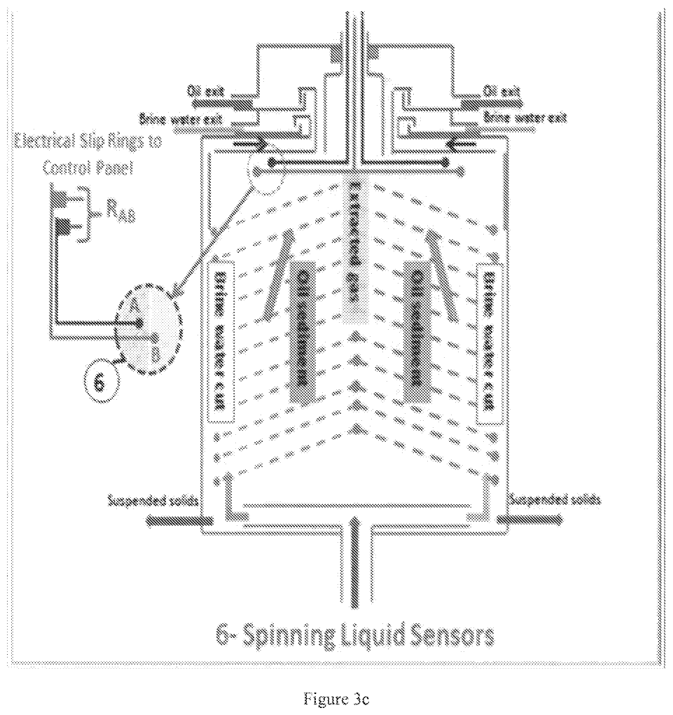

FIG. 3a illustrates weight of spinning liquid shell under the influence of α rad/s. More specifically, FIG. 3a illustrates the direction of separation of water and solids

FIG. 3b illustrates a general separation profile for a rotatable vessel, in accordance with one embodiment. The rotatable vessel provides exceptional performance efficiency and a minimal required residential time. Umbrella shaped stainless steel filters may be provided, shown in dashed lines, to reduce or eliminate liquid layers relative slippage. As shown, extracted gas travels to the center of the rotatable vessel and is directed upwardly. Brine water is directed most outwardly. Oil is directed between the gas and the brine water. Suspended solids fall out the bottom. FIG. 3b further illustrates how it is practically possible to suppress submission time, minimizing residential time to a dominant practical limit to enable scaling up the desired production capacity.

FIG. 3c illustrates the rotatable vessel, including the separation profile of FIG. 3b, spinning liquid sensors, the water outlet, the crude oil outlet, and the gas outlet. The separated brine water exits the brine water exit. The separated oil exits the oil exit. The gas exits the gas outlet. The suspended solids exit out proximate the bottom.

In order to provide relatively continuous oil-brine water separation, and to substantially avoid a oil-water mixture event, spinning sensors may be provided at a certain position where oil and water separated cylindrical shells fluctuate back and forth. A and B in FIG. 3c, shown at 6, show the relationship of the oil shell and the water shell. R_{AB} represents that relationship.

If R_{AB}≈0.0Ω then brine water could be closed to oil outlet. Accordingly, extra oil may be injected for counterbalance or the oil outlet could be temporarily closed (for example, for a packed type main outlet joint). If R_{AB}≈(open circuit), then oil may be closed to the brine water outlet. Accordingly, extra brine water may be injected for counterbalance or brine water outlet could be temporarily closed (for example, for a packed type main outlet joint). A gas and sulfur flashing mechanism is efficient where gas flashing force jumps from 0.8 grams/cm³ of gas bubbles to 8 Kg/cm³ which guarantees oil sulfur super sweetening down to 0.01 weight %.

FIG. 3d illustrates the rotatable vessel, including the separation profile of FIG. 3b, and specificity of the water outlet, the crude oil outlet, and the gas outlet. As shown, the outlets may be provided as a combined joint for liquids and gases.

To separate crude oil, crude oil is pumped into the rotatable vessel through the crude oil inlet. The rotatable assembly is rotated by the drive. The crude oil rotates with the rotatable assembly and stratifies. The water is pushed outwardly and the oil is pushed inwardly. The water outlet directs the water out of the rotatable assembly. The crude oil outlet directs the crude oil outlet of the rotatable assembly. Solid particulate, such as a TSS slurry, migrates to the sides of the rotatable vessel and slide downwardly and is directed to an particulate discharger for removal and processing. Natural gas, hydrogen sulfide (H₂S) migrates to the center of the rotatable assembly and flows upwardly to an oil-gas seal. The oil-gas seal may comprise a gas plenum with liquid buffers to neutralize the H₂S. The oil-gas seal may be stationary. The liquid buffers may comprise sodium hydroxide (NaOH) and the NaOH may react with the H₂S to form sodium sulfide (Na₂S). In general, such an oil-gas seal may have liquid or gas buffers of any strong base to react with a strong acid to form, for example, salt and water. The oil-gas seal thus assists in cooling and protects against leakage of hazardous H₂S.

A method of purifying crude oil is thus provided. The method includes directing a stream of crude oil into a rotating chamber of a separation device, and causing the crude oil to rotate with the rotating chamber of the separation device to cause the crude oil to stratify along a radial direction into a gaseous component, a purified oil component, a water component, and a solids component. The method may further comprise causing the gaseous component to be evacuated through a gas evacuation tube in a central region of the separation device, causing the purified oil to exit through an oil exit port located radially outwardly from the gas evacuation tube, and causing the water component to exit through a water exit port located radially outwardly with respect to the oil exit port.

The method may further comprise continuously operating the separation device, continuously introducing crude oil into the separation device, and continuously evacuating oil and water from the separation device. The solids component may be evacuated through a solids evacuation port of the separation device. More specifically, the solids component may be directed in a slurry form into a solids separation strainer.

The method may further comprise directing the gaseous component into a stationary chamber of an oil-gas mechanical seal located at an upper end of the separation device, the oil-gas mechanical seal including a plurality of mechanical seals that rotatably receive the upper end of the separation device. The oil-gas separation device may further include liquid reservoirs located above and below the stationary chamber, wherein gas that leaks past the plurality of mechanical seals is intercepted and neutralized by the liquid reservoirs. The gas that leaks past the plurality of mechanical seals that is intercepted by the liquid reservoirs may comprise hydrogen sulfide.

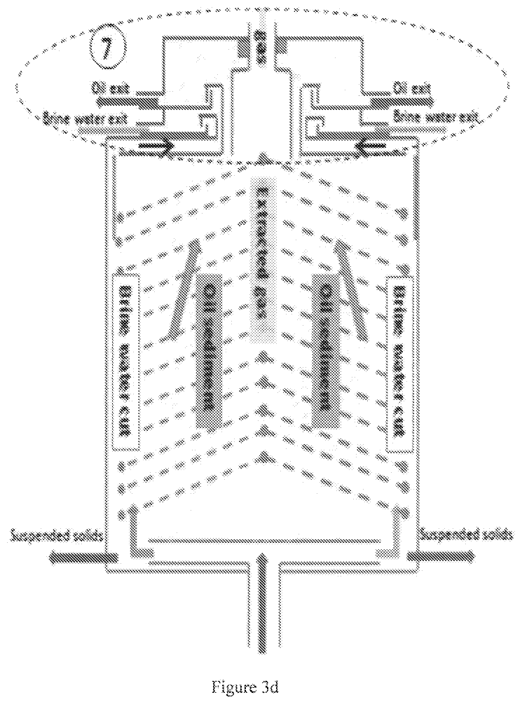

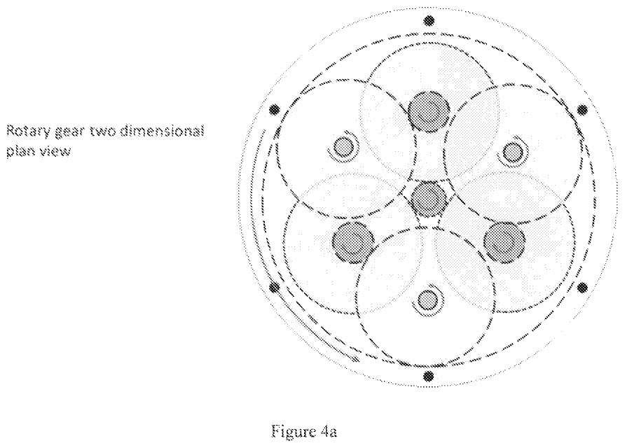

FIG. 4a illustrates a drive gear mechanism, in accordance with one embodiment. In this embodiment, a reduction speed planetary gear driven by a main driving motor is used to have a sampling disk speed of 2 rpm wherein a gear driving shaft runs at 70 rpm with respect to the spinning cylinder.

FIG. 5 illustrates a gas-oil mechanical seal 54, in accordance with one embodiment. The gas-oil mechanical seal 54 may be used to neutralize harmful gases. The gas-oil mechanical seal may include a gas receiving chamber 100 and liquid filled reservoirs 102, 104 disposed above and below the gas receiving chamber 100. The gas receiving chamber 100 may be coupled to a gas inlet and a gas outlet. The gas receiving chamber may be configured to rotatably receive a rotating tubular conduit 106 directing a gas flow. The liquid filled reservoirs 102, 104 disposed above and below the gas receiving chamber 100 may be configured to receive gas leaking past seals 108, 110 of the gas receiving chamber. In some embodiments, the gas-oil mechanical seal may comprise four cascading chambers 112, 102, 100, 104 separated by four mechanical seals 114, 108, 110, 116. The mechanical seals 114, 108, 110, 116 may be configured to withstand conditions of pH ranging from 1 to 14, temperature of −50° C. up to 300° C., and pressures up to 300 bars. In one embodiment, the mechanical seals 114, 108, 110, 116 are tungsten carbide seals.

The oil-gas mechanical seal 54 may be disposed at an upper end of the apparatus, and may have an interior chamber in fluid communication with an upper end of the vertically disposed gas evacuation plenum. The vertically disposed gas evacuation plenum directs gases extracted from crude oil into a gas receiving chamber of the oil-gas mechanical seal. The gas receiving chamber of the oil-gas mechanical seal is coupled to at least one gas exit port to transport gases out of the apparatus, the chamber of the oil-gas mechanical seal is bounded by a peripheral wall, an upper wall and a lower wall. The upper wall and the lower wall of the oil-gas mechanical seal may each be bounded by a liquid reservoir, such as a solution of sodium hydroxide (NaOH), to address gas leakage from the chamber of the oil-gas mechanical seal. This may be, for example, by reacting with the gas hydrogen sulfide (H₂S) leakage to generate sodium sulfide (Na₂S). In other embodiments, a different liquid may be provided as the liquid reservoir and different mechanisms for addressing the gas leakage, such as absorption of the gas, may be done.

The oil-gas mechanical seal may be stationary with respect to the rotating assembly. The oil-gas mechanical seal may receive an upper portion of the rotating assembly therein that includes the upper end of the vertically disposed gas evacuation plenum. The oil-gas mechanical seal may include a plurality of seals that seal against the upper end of the vertically disposed gas evacuation plenum.

A suspended solids discharging valve, also referred to as a particulate discharger, may be provided in fluid communication with a solids discharge port or the crude oil separation system. The suspended solids discharging valve may be located at least partially underneath the crude oil processing chamber of the rotatable assembly. The suspended solids discharging valve may include a sampling disc that defines at least one solids evacuation conduit formed therein, the sampling disc being configured to rotate relative to a lower wall of the crude oil processing chamber. The lower wall of the crude oil processing chamber may define at least one opening therethrough. Relative rotation of the sampling disc with respect to the lower wall of the crude oil processing chamber causes the at least one opening in the lower wall of the crude oil processing chamber to align with the at least one solids evacuation conduit of the sampling disc for a predetermined period of time to cause solids to be transported from the crude oil processing chamber, through the at least one opening in the lower wall of the crude oil processing chamber, and into the at least one solids evacuation conduit of the sampling disc. This may be configured as an always closed/always open discharge system. When discharging solids, the contents inside the vessel are not exposed to the outer atmosphere. When the at least one opening in the lower wall of the crude oil processing chamber is aligned with the at least one solids evacuation conduit of the sampling disc, the solids pass through. As they rotate away from one other, they dispose of the solids while sealed away from the contents of the vessel.

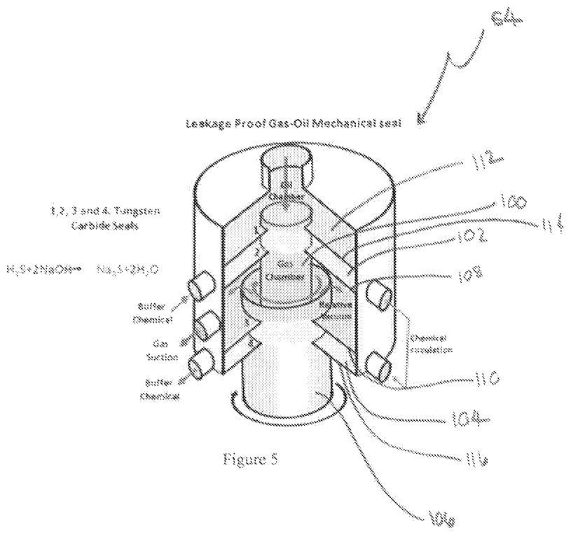

The sampling disc is caused to rotate relative to the lower wall of the crude oil processing chamber by a gear train driven by a second drive. The gear train may be, for example, a planetary gear train. FIG. 6c illustrates an isometric view of a cascaded rotary gear in the center disc of the particulate discharger, in accordance with one embodiment.

The rotating assembly may be configured to rotate at a first speed and the sampling disc may be configured to rotate at a second speed different from the first speed in order to permit relative rotation of the sampling disc to the crude oil processing chamber. In some embodiments, the first speed is within about one percent of the second speed. In some embodiments, the first speed and second speed differ by between about one revolution per minute and about ten revolutions per minute. In some embodiments, the first speed is between about 500 revolutions per minute and about 5000 revolutions per minute.

The suspended solids discharging valve may further include a discharge ring including at least one radially outwardly facing discharge port, wherein solids are conveyed by the sampling disc to the at least one radially outwardly facing discharge port.

FIGS. 6a and 6b illustrate a specific embodiment of a suspended solids discharging valve 56, or particulate discharger, in accordance with one embodiment. Referring back to FIG. 2c, the particulate discharger 56 may be provided below the rotatable vessel 58. The particulate discharger may comprise a suspended solids discharging spinning system. In some embodiments, the particulate discharger 56 may comprise a spinning valve discharging system. In the embodiment shown, three layers or discs 120, 122, and 124 are packed together to form one spinning cylinder carrying flange. The lower disc 120 may have a peripheral lip or rim 126 for receiving the center disc and comprises the discharge ring discussed above. The upper disc 124 receives the suspended solids and may seal the center disc within the lower disc. The upper disc may comprise the sampling disc described above. The center disc 122 may include the gear train 128 shown in FIG. 6c.

A central crude oil inlet 130 may be provided in the upper disc 124, and is in fluid communication with the solids discharge port of the rotating assembly. A plurality of TSS slurry exit holes 132 are provided through each of the three discs 120, 122, 124. In the upper disc 124, the exit holes 132 may be positioned between the crude oil inlet 130 and the periphery. In the center disc 122, the exit holes 132 may be generally proximate the periphery. In the lower disc 120, the exit holes 132 may be through the rim 126. In general, when the discs 120, 122, and/or 124 are aligned such that the exit holes align, the solids push through the upper disc 124 into the center disc 122, through the center disc 122 to the lower disc 124, and out the exit holes 132 of the lower disc 120. A solid discharging mechanism works directly on the cylinder wall for forcing solids to the rim to be discharged through the exit holes.

The particulate separator keeps the spinning exposed media enclosed. A buffer valve adopting sampling mechanism is provided for the enclosed cylindrical samples. A case study was performed using a 25 mm diameter with a 20 mm thickness with (6 holes*6 exits*2 net rev. per min.*sample volume)=707 ml. of slurry/min. This resulted in 1400 gram of suspended sand. Assuming 300 ppm in crude oil, the disclosed system has a discharging capacity capable of covering approximately 4.7 barrels/min.=6720 barrels a day.

FIG. 7 illustrates a slurry separator or strainer 150, in accordance with one embodiment. As shown, the slurry separator 150 includes a slurry mixture inlet 152, a brine water separation mesh 154, a brine water outlet 156, and a total suspended solids outlet 158. The slurry strainer 150 may be coupled directly, or indirectly, to where solid is discharged from the solids discharging valve. This may be, for example, along a slurry mixture path outlet at the exterior of the separation system, such as a drain pipe.

As discussed above, a solids discharge port may be provided as part of the suspended solids discharging valve 56 and configured to direct a slurry of material including solids into a strainer 150 to further separate the solids from liquid components of the slurry. The strainer may include an elongate outer vessel 151 and an elongate porous inner vessel 153 disposed within the elongate outer vessel 151. The elongate porous inner vessel 151 may comprise a brine water separation mesh 154. The elongate porous inner vessel 151 may have a motorized screw auger 155 disposed therein. As previously described, the strainer 150 may have a slurry inlet 152 to direct slurry into the elongate inner vessel 153, a solids outlet 158 in mechanical communication with the elongate inner vessel 153, and a liquid outlet 156 in communication with the outer vessel 151. The slurry inlet 152 directs slurry into the elongate inner vessel 153 wherein the screw auger 155 advances the slurry toward the solids outlet 158. Liquid is transported from the slurry and into a chamber 157 defined between the elongate outer vessel 151 and the elongate porous inner vessel 153 to separate liquid from the solids in the slurry. The strainer may be inclined at an angle to cause the screw auger 155 to advance the solids upwardly as the solids are separated from the liquid of the slurry.

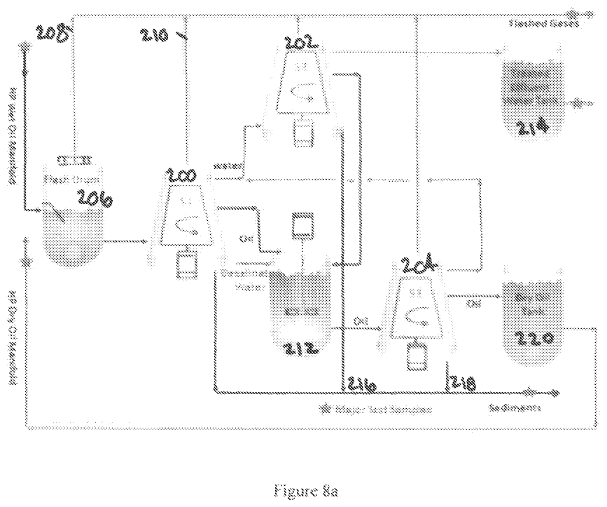

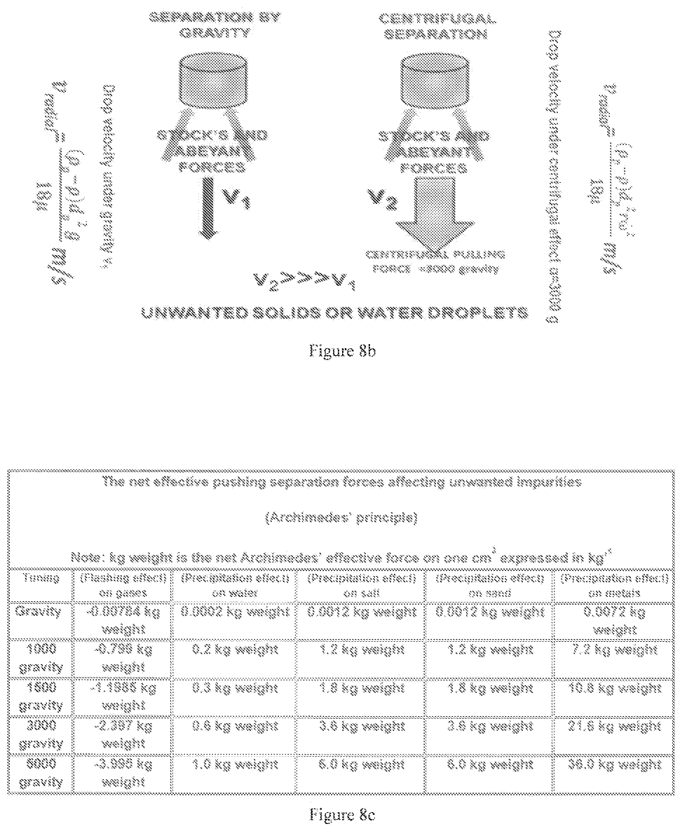

FIG. 8a illustrates a system and process flow diagram, in accordance with one embodiment. In the system shown in FIG. 8a, three separators S1 200, S2 202, and S3 204 are provided. Fluids are routed to a degasser flash drum 206. This extracts most of the gas content and routes it along line 208. Fluid is routed to a bulk water separator 200. The bulk water separator 200 may be a tri-phase separator. At this stage, gas separated in the bulk water separator is routed to join the gas from the flash drum 206 along line 210. Fluids are segregated into oil and water with water being routed to a second separator 202 and oil being routed to an oil processing vessel 212. The second separator 202 separates any remaining oil and routes it to the oil processing vessel 212. The second separator 202 routes the separated water, which is substantially gas and oil free, to a water tank 214. Sediment from the second separator 202 is routed along line 216. Oil is routed to a third separator 204 where any remaining gas, water, and sediments are extracted. Sediment is routed to join sediment from the second separator 202 along line 218. Oil is routed to an oil tank 220. Accordingly, at the end of the process, four major products are present: oil (in oil tank 220), water (in water tank 214), gas (optionally in a holding tank, not shown), and solids (optionally in a holding tank, not shown). The disclosed separation system addresses problems unsolved by the currently used oil-treatment technology. It minimizes power and water consumption and increases crude-oil production capacity.

Various performance characteristics and principles behind such characteristics will now be discussed. Archimedes principle is a law of physics fundamental to fluid mechanics and is referenced in discussion of the performance of the disclosed system. Archimedes principle states that the upward buoyant force that is exerted on a body immersed in a fluid, whether fully or partially, is equal to the weight of the fluid that the body displaces. More specifically:

the net or resultant force affecting any unwanted impurity=(impurity density/cm³−carrying fluid density/cm³)*retarding acceleration.

The anticipated numeric result is severely amplified and quadratically related to the operating frequency. FIG. 8b illustrates velocity drop under gravitational separation and velocity drop under centrifugal separation. More specifically, FIG. 8b illustrates the efficiency difference between separation using a gravitational process and separation using a centrifugal process. FIG. 8c illustrates the net effective pushing separation forces affecting unwanted impurities, in accordance with the Archimedes principle.

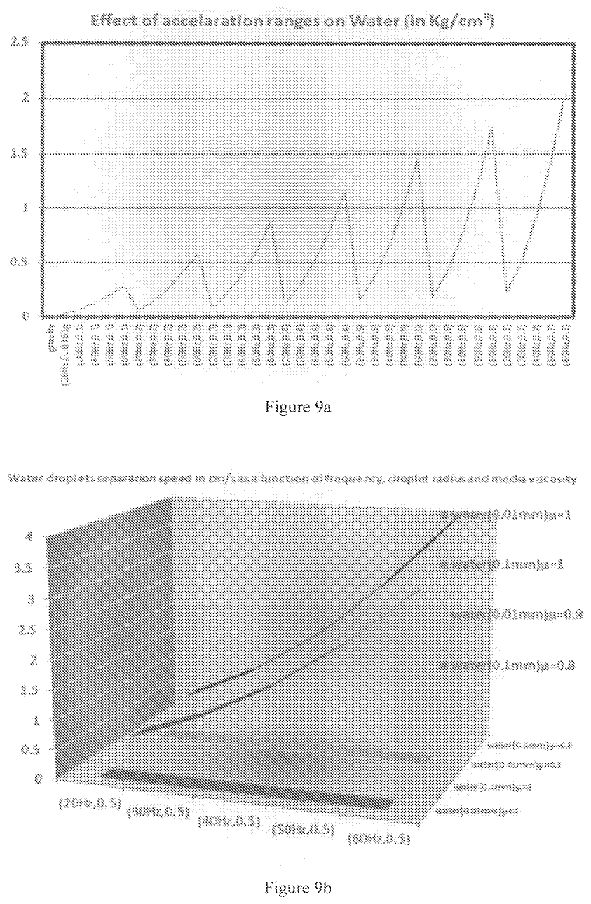

Dehydration. The separation system is an efficient heavy crude oil de-hydrator. Note: Kg weight means 1 kg*9.81=9.81 Newtons. The net precipitation effective force (Archimedes principle) affecting one cubic centimeter of water accelerates under gravity from:
0.2 gram weight/cm³ of water=(0.001962 N), to:
1. 0.2 kg weight/cm³ of water (under 1000 gravity effect) Up to:
2. 0.3 kg weight/cm³ of water (under 1500 gravity effect) Up to:
3. 0.6 kg weight/cm³ of water (under 3000 gravity effect) Up to:
4. 1.0 kg weight/cm³ of water (under 5000 gravity effect).
   Therefore, any water cut percentage may be reduced to a minimal amount, even in a foam state. FIGS. 9a and 9b illustrate the effect of acceleration ranges on water and the water droplets separation speed, respectively.

Total Suspended Solids (TSS). In general, any value of TSS may be reduced to, for example, 35 ppm. Using the crude oil separation system and device, the net precipitation effective force (Archimedes principle) affecting one cubic centimeter of sand accelerates under gravity from:
1.2 gram weight/cm³ of sand=(0.011772 N), to:
1. 1.2 kg weight/cm³ of sand (under 1000 gravity effect). Up to:
2. 1.8 kg weight/cm³ of sand (under 1500 gravity effect). Up to:
3. 3.6 kg weight/cm³ of sand (under 3000 gravity effect) Up to:
4. 6.0 kg weight/cm³ of sand (under 5000 gravity effect).
   FIG. 10a illustrates the effects of acceleration ranges on sand. FIG. 10b illustrates the effects of acceleration ranges on marble and solids. FIG. 10c illustrates the effects of acceleration ranges on limestone. FIG. 11 illustrates sand separation speed in cm/s as a function of frequency, impurity radius, and media viscosity.

TSS Separation. Suspended solids densities vary between 2 and 8 grams/cm³, earning an efficient net extraction and precipitation force of 6.0-36.0 Kg per one gram of a blend under 5000 g centrifugal acceleration effect invoking Bernoulli's principle. The crude oil separation system, device, and method enable an efficient extraction of any solid granule regardless of its volume from its charging media, retaining it at a discharging exit regardless of the flow rate of the blend and the pressure difference between the layers.

TSS Scrubbing. Accumulating solids within the crude oil separation system and device may be scrubbed during the separation process.

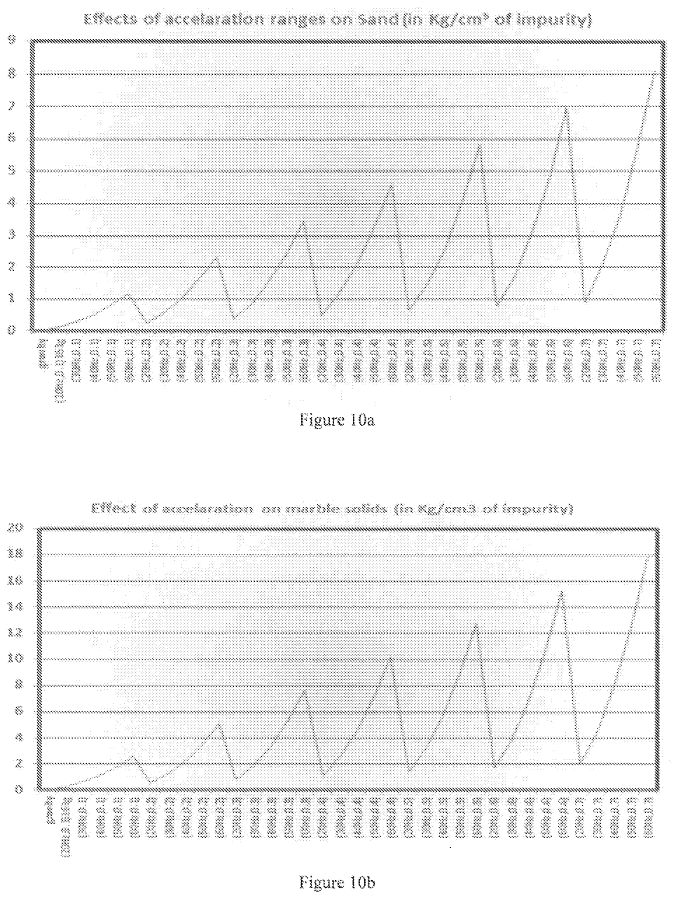

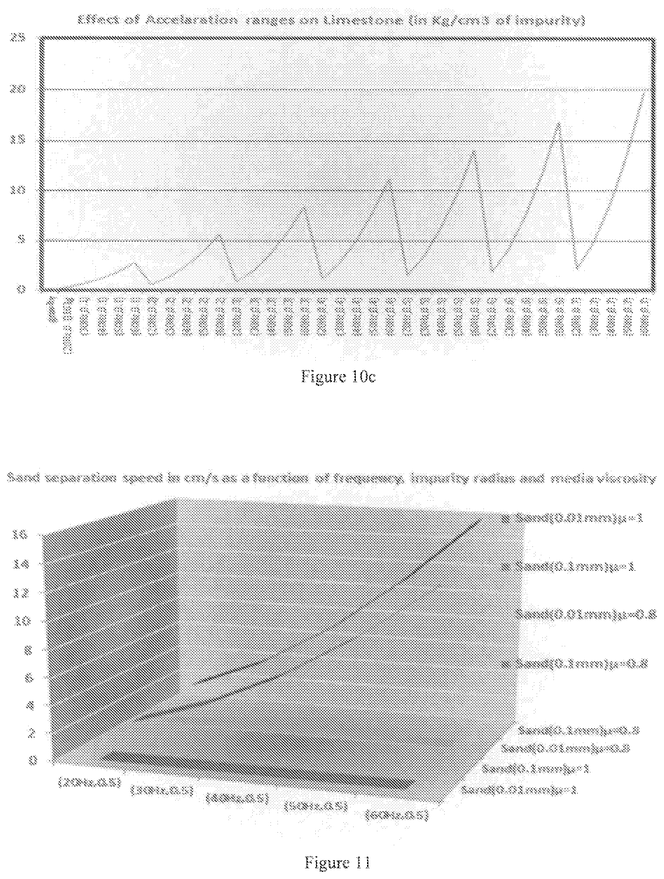

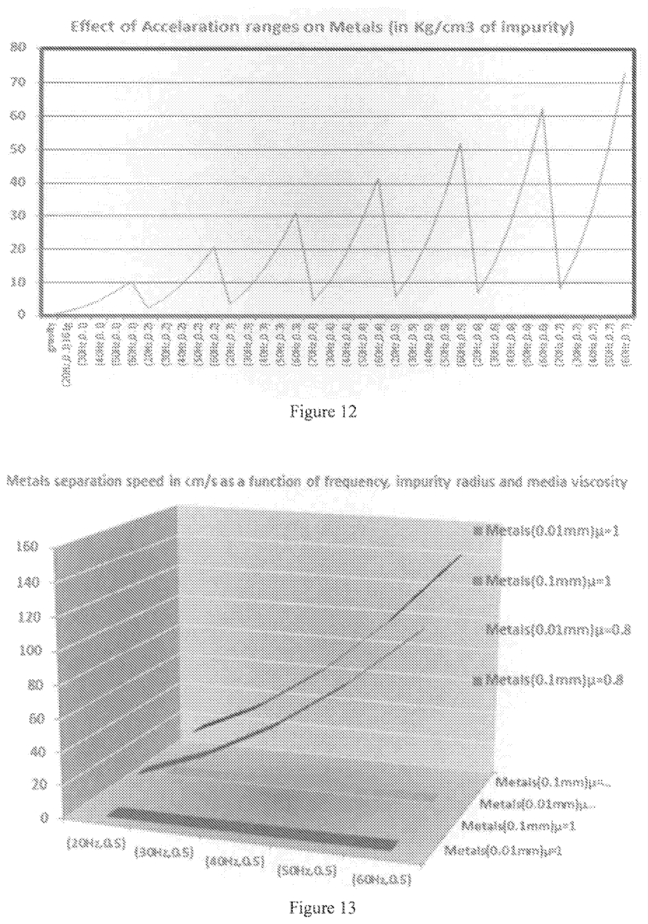

Suspended Solids (SS) Volume. In general, any value of separate SS volume may be reduced to a few microns. Using the crude oil separation system and device, the net precipitation effective force (Archimedes principle) affecting one cubic centimeter of metal granules accelerates under gravity from:
7.2 gram weight/cm³ of metal pellet=(0.070632 N), to:
1. 7.2 kg weight/cm³ of metal pellet (under 1000 gravity effect). Up to:
2. 10.8 kg weight/cm³ of metal pellet (under 1500 gravity effect). Up to:
3. 21.6 kg weight/cm³ of metal pellet (under 3000 gravity effect). Up to:
4. 36.0 kg weight/cm³ of metal pellet (under 5000 gravity effect).
   FIG. 12 illustrates the effect of acceleration on metals. FIG. 13 illustrates metals separation speed in cm/s as a function of frequency, impurity radius, and media viscosity.

Media Viscosity. The crude oil separation system and device can overcome any main media viscosity. Stocks and abeyant forces cannot withstand the efficient retarding force.

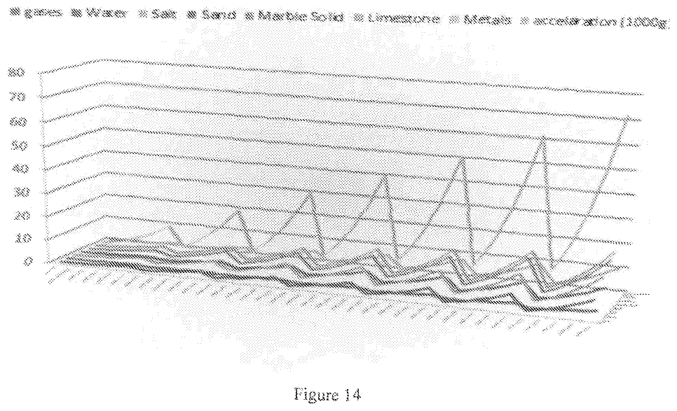

Sludge Sediment. Using the crude oil separation system and device, any sludge sediment is de-assembled. The oil is thus lighter. FIG. 14 illustrates separation solidarity using a crude oil separation system in accordance with an embodiment disclosed herein.

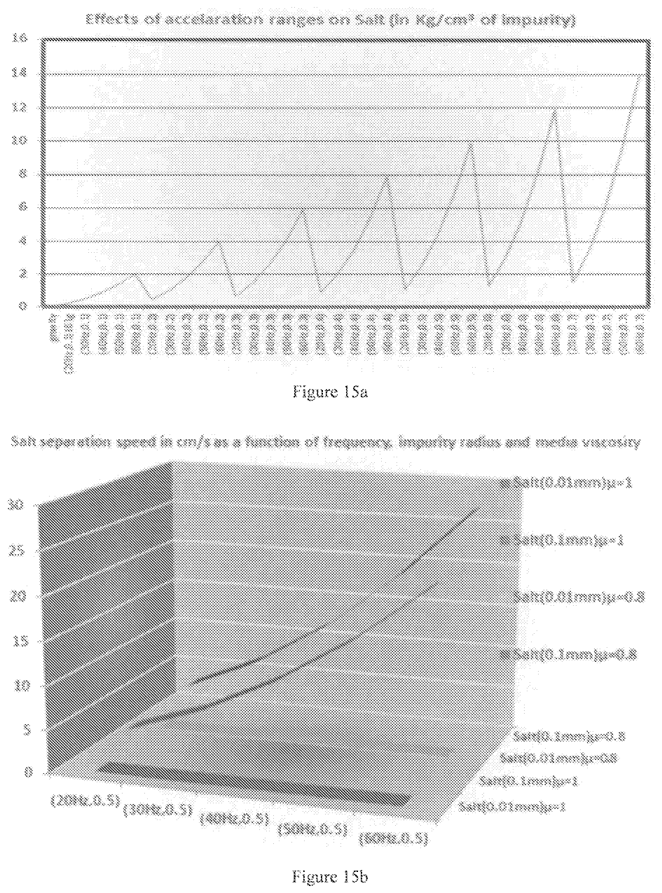

De-Salting. The crude oil separation system and device is an efficient heavy crude oil de-salter that minimizes required water quantities for the desalting. Using the crude oil separation system and device, the net precipitation effective force (Archimedes principle) affecting one cubic centimeter of salt accelerates under gravity from:
0.8-gram weight/cm³ of salt=(0.00785 N), to:
1. 0.8 kg weight/cm³ of salt (under 1000 gravity effect). Up to:
2. 1.2 kg weight/cm³ of salt (under 1500 gravity effect). Up to:
3. 2.4 kg weight/cm³ of salt (under 3000 gravity effect). Up to:
4. 4.0 kg weight/cm³ of salt (under 5000 gravity effect).
   FIG. 15a illustrates the effects of acceleration ranges on salt. FIG. 15b illustrates salt separation speed in cm/s as a function of frequency, impurity radius, and media viscosity.

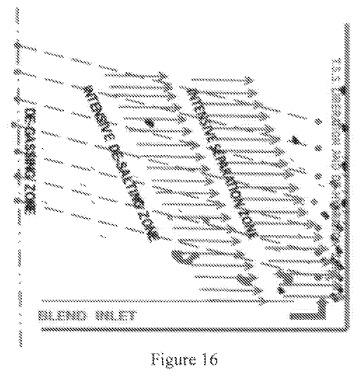

Oil De-salting. The weight of suspended salt granules may be amplified 3000-5000 times. This disperses salt pellets through viscous fluid directly to a discharging main exit of the separation device and system. FIG. 16 illustrates de-sludging, de-salting, and de-gassing profiles.

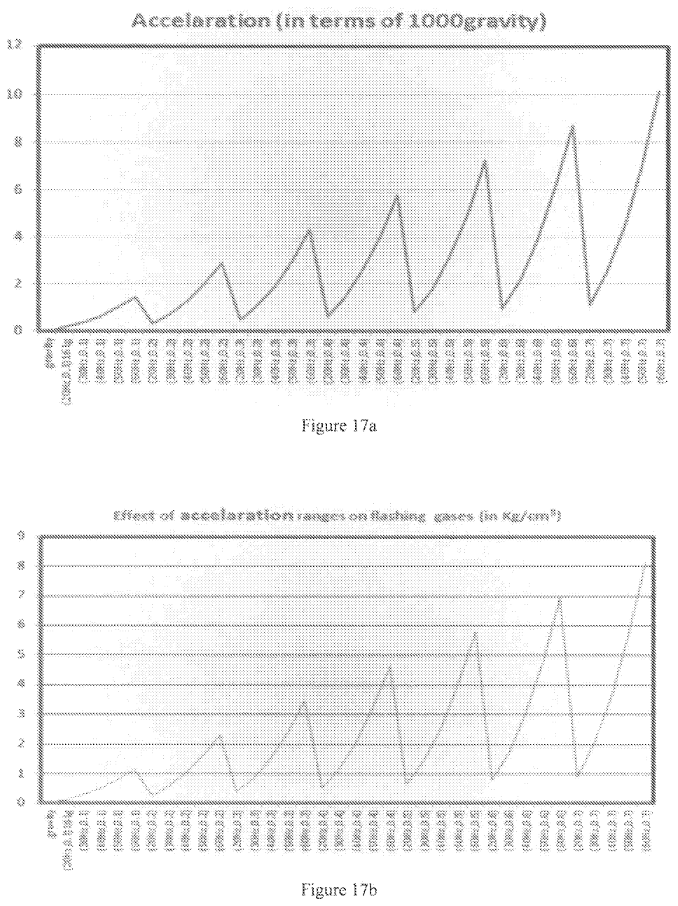

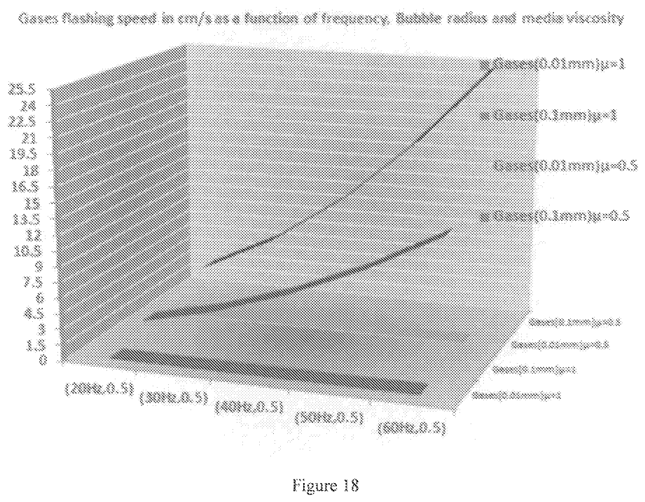

De-gassing. The crude oil separation system and device is an efficient degasser. The inner separated shell of crude oil comprises gas bubbles extracted from oil sediment as liberated unwanted associated gasses. The separated oil is nearly gas free. As a result, the net floating and flashing effective force (Archimedes principle) affecting one cubic centimeter of gas accelerates under gravity and traditional degassing operating conditions from:
**(0.001-0.80) g weight/cm³ of gas=−0.79 g weight=−(0.00775 N), to:
   1. (0.799 kg weight/cm³ of gas) flashing force (under 1000 gravity effect). Up to:
   2. (1.1985 kg weight/cm³ of gas) flashing force (under 1500 gravity effect). Up to:
   3. (2.397 kg weight/cm³ of gas) flashing force (under 3000 gravity effect). Up to:
   4. (3.995 kg weight/cm³ of gas) flashing force (under 5000 gravity effect).
** Where gas bubbles will be strongly replaced by oil under a net pressure of (0.00079*centrifugal acceleration/9.81) in kg weight.
   Oil from the crude oil separation system and device thus is almost sweetened and free of acidic gases such as hydrogen sulfide. FIG. 17a illustrates the acceleration ranges in terms of 1000 gravity effect. FIG. 17b illustrates the effect of acceleration ranges in flashing gases. FIG. 18 illustrates gases flashing speed in cm/s as a function of frequency, bubble radius, and media viscosity.

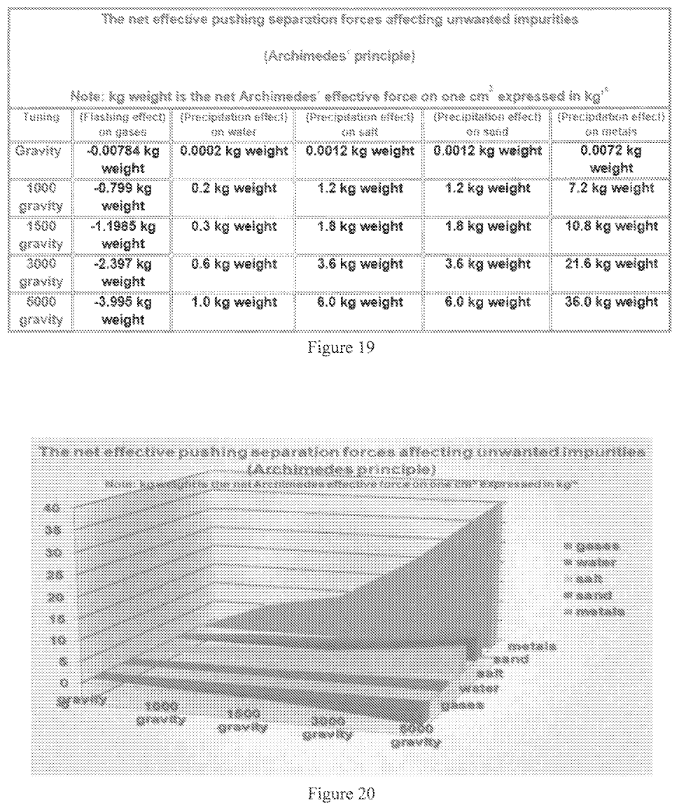

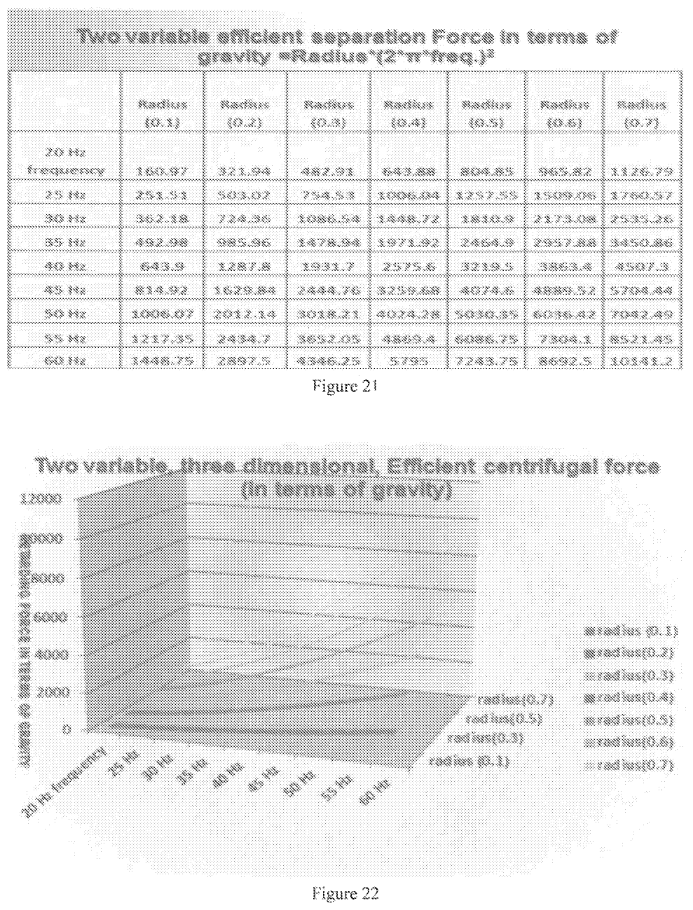

Tunable Performance. The crude oil separation system and device has tunable performance efficiency. FIG. 19 illustrates a three-dimensional frequency performance chart. More specifically, FIG. 19 illustrates the net effective numerical pushing separation forces affecting unwanted impurities. FIG. 20 illustrates the net effective pushing separation forces affecting unwanted impurities. FIG. 21 illustrates the efficient separation force in terms of gravity. More specifically, FIG. 21 illustrates the two variable efficient separation force in terms of gravity. FIG. 22 illustrates the three dimensional efficient centrifugal force in terms of gravity. More specifically, FIG. 22 illustrates two variable, three dimensional, efficient centrifugal forces in terms of gravity.

Production Capacity. Using the crude oil separation system and method, production capacity can be expandable while keeping power consumption in a desired permissible range. This results in a decrease in power consumption.

Purification Stages. The purification stages achievable using the crude oil separation system and method include: submission profiles, de-hydration, sludge sediment de-assembling, TSS separation, oil de-salting, TSS scrubbing, and de-gassing.

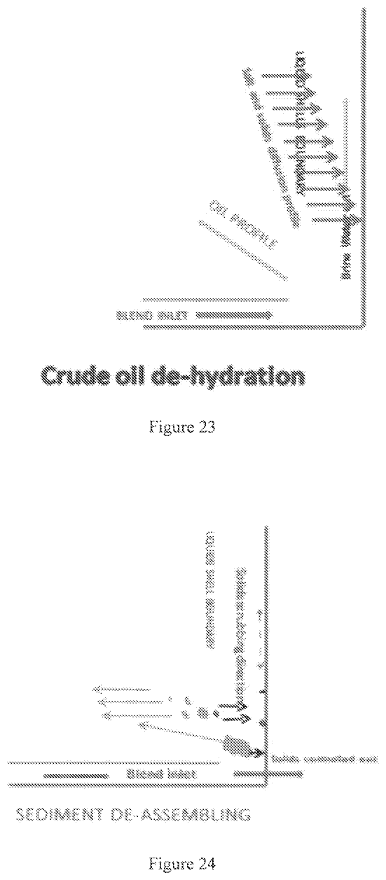

De-hydration. By exposing the crude oil blend to the equivalent of about 3000-5000 times the gravitational acceleration effect; the relative weight difference, which is the effective precipitation force of oil and water, exceeds 600-1000 grams for each gram of water. This pushing force overcomes stocks abeyant and even any high cohesion forces between blend layers, enabling very small water droplets to penetrate any highly viscous fluid. FIG. 23 illustrates the process of crude oil de-hydration.

Sludge sediment de-assembling. Using the crude oil separation system and device, the rotational acceleration, which is equivalent to 3000-5000 of that of the gravitational acceleration, generates a relative weight difference between oil and most suspended solids that may exceed (3.6-6.0) Kg for sand in general, and 21.6-36.0 Kg for some metals per one gram of oil. The process results in forced sediment de-assembling in opposite directions. This force split into two opposite forces pushes solids towards the outside and the thick oil or petroleum to the center. FIG. 24 illustrates the sediment de-assembling process.

Indirect positive technical results of the crude oil separation and oil de-hydration include:
The output oil is substantially de-salted.
Water needed for de-salting process is decreased.
Needed chemical catalysts are lowered.
Heating up oil-water blend for de-hydration is not needed.
Oil residential time in de-salting is decreased and productivity is thereby increased.
Pipes and fittings deterioration is minimized.
Most maintenance needs and periodic blockage are minimized by the substantial absence of sludge sediment.
Standstill environmental impacts stemming from dumping areas are controlled after sludge elimination.
Precipitated sludge in storage vessels is lowered.

It is to be appreciated that the system, device, apparatus, and/or method, and/or component parts thereof may be applied to fields other than crude oil separation. For example, one or more may be useful in industrial water treatment, which is typically contaminated with oil and grease. One or more may be useful in a grease trap to serve as a main residential complex or district sharp grease trap before spilling into a sanitary network. One or more may be useful in separating moisture out of produced fluids in oil extraction lines. One or more may be useful in separating suspended solids out of sewage and industrial water.

The crude oil separation system, device, and method takes advantage of physics and fluid mechanics in oil purification technology. This is explained below. For the purposes of this discussion, the following definitions are used:
Liquid stroke: is initially the net vertical distance between interior inlet and outlet. (Referred to as (h₂−h₁)).
A₁=main inlet sectional area.
A₂=main interior outlet area.
P₁=main interior inlet.
P₂=main interior outlet.
ρ=blend density.
G=9.8 m/s². (Gravitational Acceleration)
(P₁+ρgh₁+1/2 gv₁²=p₂+ρgh₂+(1/2 gv₂²)) so
P₂=p₁+ρg(h₁−h₂)+(1/2 g(v₁²−v₂²)). Unit: kg/ms².
   Assume that (h₁−h₂)=1 m with flow rate 200 barrels/day
(i.e.: 2.3 liter/s., 2-inch Nozzle, so v₁=1.17 m/s, v₂=0.0029 m/s).
P₂=P₁+(1000*9.81+1/2*9.81((1.17)2−(0.0029)²))/(101,300) atm=(P₁+9816.71/101,300 atm)=P₁+0.0969 atm.
   The obtained increment is almost negligible that will not deviate impurities using the separation method.

Using the disclosed separation system, method, and process, the following performance parameters are achieved.

Radial separation velocity: The net or resultant precipitation forces affecting a certain particle of diameter dp immersed in a viscous oil of ρₒᵢₗ density in a centrifugal separator are its original weight opposed by oil carrying force according to Archimedes principle and abeyant force as it is moving

$$( \frac{π {{d}_{p}}^{3}}{6} {ρ}_{particle} ) \frac{dv}{dt} = ( \frac{π {{d}_{p}}^{3}}{6} {ρ}_{particle} ) r {ω}^{2} - ( \frac{π {{d}_{p}}^{3}}{6} {ρ}_{oil} ) r {ω}^{2} - 3 πμ {d}_{par} {v}_{radial}$$

and as velocity is constant with respect to time, not with position:

$$\frac{{{πd}_{p}}^{3} r {ω}^{2}}{6} ( {ρ}_{par} - {ρ}_{oil} ) - 3 πμ {d}_{par} {v}_{rarial} = 0. , so {v}_{radial} = \frac{{{πd}_{p}}^{3} r {ω}^{2} ( {ρ}_{par} - {ρ}_{oil} )}{18 {μd}_{{p}_{p}}} = \frac{( {ρ}_{par} - {ρ}_{oil} ) {{d}_{p}}^{2} r {ω}^{2}}{18 μ}$$

$${v}_{radial} = \frac{( {ρ}_{par} - {ρ}_{oil} ) {{d}_{p}}^{2} r {ω}^{2}}{18 μ}$$

### Residential Time:

$${v}_{radial} = \frac{( {ρ}_{par} - {ρ}_{oil} ) {{d}_{p}}^{2} r {ω}^{2}}{18 μ} m / s = dr / dt . So ; {\int }_{{r}_{a}}^{{r}_{b}} \frac{dr}{r} = {\int }_{0}^{{t}_{res}} \frac{( {ρ}_{par} - {ρ}_{oil} ) {{d}_{p}}^{2} r {ω}^{2}}{18 μ} dt ln ( \frac{rb}{ra} ) = \frac{( {ρ}_{par} - {ρ}_{oil} ) {{d}_{p}}^{2} r {ω}^{2}}{18 μ} {t}_{res} , so ; {t}_{res} = \frac{18 μ}{( {ρ}_{par} - {ρ}_{oil} ) {{d}_{p}}^{2} {ω}^{2}} ln ( \frac{rb}{ra} ) sec .$$

### Productivity:

$${t}_{res} = \frac{18 μ}{( {ρ}_{par} - {ρ}_{oil} ) {{d}_{p}}^{2} {ω}^{2}} ln ( \frac{rb}{ra} ) sec . = \frac{v}{q} , so ; q = \frac{V}{tres} = \frac{π h ( {{r}_{2}}^{2} - {{r}_{1}}^{2} ) ( {ρ}_{par} - {ρ}_{oil} ) {{d}_{p}}^{2} {ω}^{2}}{18 μln ( \frac{rb}{ra} )} m 3 / sec .$$

### Machine Equivalence:

$$radial = \frac{( \frac{s}{2} )}{{t}_{res}} = \frac{s}{2 ( \frac{V}{q} )} = \frac{( {ρ}_{par} - {ρ}_{oil} ) {{d}_{p}}^{2} r {ω}^{2}}{18 μ} = q \frac{s}{2 v} , q = \frac{v}{tres} = \frac{2 V}{s} \frac{( {ρ}_{par} - {ρ}_{oil} ) {{d}_{p}}^{2} r {ω}^{2}}{18 μ} to be rewritten as : q = \frac{2 π {s}^{2} hr {ω}^{2}}{sg} \frac{( {ρ}_{par} - {ρ}_{oil} ) {{d}_{p}}^{2} g}{18 μ} = \sum \frac{( {ρ}_{par} - {ρ}_{oil} ) {{d}_{p}}^{2} g}{18 μ} ,$$

Σ=effective separation area*centrifugal separation factor (m2)

$$So ; \sum = 2 π sh \frac{r {ω}^{2}}{g} {m}^{2}$$

Total pressure stemmed from centrifugal force (see FIGS. 3a and 2b):

$${\int }_{{R}_{1}}^{{R}_{2}} 2 π Rdrh * ρ * R {ω}^{2} = {\int }_{{R}_{1}}^{{R}_{2}} 2 π h {ρω}^{2} {R}^{2} dr = 2 π h {ρω}^{2} ( \frac{1}{3} ( {{R}_{2}}^{3} - {{R}_{1}}^{3} ) )$$

The actual fluid weight between R1 and R2 thus will be

$$= \frac{2}{3} π h ρ {ω}^{2} ( {R}_{2}^{3} - {R}_{1}^{3} )$$

### Newton.

Based on FIG. 3a, the discharging stability in this communicating vessel system is established once pressure of the two chambers C1 and C2 (see FIG. 2b) become equal.

So:

$$\frac{2 π {h}_{1} {ρ}_{1} {ω}^{2} ( \frac{1}{3} ( {R}^{3} - {{R}_{1}}^{3} ) )}{2 π h 1 R} = \frac{2 π {h}_{2} {ρ}_{2} {ω}^{2} ( \frac{1}{3} ( {R}^{3} - {{R}_{2}}^{3} ) )}{2 π h 2 R}$$

$${ρ}_{1} ( {R}^{3} - {{R}_{1}}^{3} ) = {ρ}_{2} ( {R}^{3} - \text{?} ) \qquad {R}^{3} = \frac{1}{( {ρ}_{1} - {ρ}_{2} )} ( {ρ}_{1} {{R}_{1}}^{3} - {ρ}_{2} {{R}_{2}}^{3} )$$

$$\text{?} \text{indicates text missing or illegible when filed}$$

R₂ (Oil discharging radius): could be deduced by the inlet or feeding pipe diameter (Normally 6 inches.) and gas chamber vacancy. (Its normally 20 cm) R (Equilibrium radius): deduce chamber volumes that is governed by the preassigned residential times of both water and oil.

$${{R}_{out}}^{2} - {R}^{2} = A ( \text{?} ) \qquad {R}^{2} = \frac{1}{( A + 1 )} ( {{R}_{out}}^{2} + {{AR}_{2}}^{2} )$$

$$\text{?} \text{indicates text missing or illegible when filed}$$

where Factor A could be as follows:

For bulk water separation out of Crude oil emulsion
$A = 1 / 3 for k = \frac{{water}_{percentage}}{{oil}_{percentage}} \approx 1 - 3.$ [symbol]
Water tᵣₑₛ = (60/k) * A = (7-20) sec. (regular crude oil).
$A = 1 / 2 for k = \frac{{water}_{percentage}}{{oil}_{percentage}} \text{?} 4 - 6.$
Water tᵣₑₛ = A * (60/k) = (5-7.5) sec. (regular crude oil).
$A = 0.65 for k = \frac{{water}_{percentage}}{{oil}_{percentage}} \text{?} 7 - 9.$
Water tᵣₑₛ = A * (60/k) = (4.5-5.5) sec. (regular crude oil).
For effluent water treatment A = 20. (Pretreated product).
For Crude oil treatment A = 1/8. (Pretreated product).
$\text{?} \text{indicates text missing or illegible when filed}$

Oil-water depletion region stability: As explained above, a cylindrical shell separates oil and water. To discharge both liquids at a rate suitable to their percentages i.e. balanced process, the stability of the shell was assessed. Shell volume=2πhRdr, shell mass=2πhρRdr Shell weight=2πhρω²R²dr. Note: variation between water and oil create an instantaneous density difference of 0.2 g/cm³ Case study: Bulk water separation machine running at 1800 rpm:

$( k = \frac{{water}_{percentage}}{{oil}_{percentage}} ) = 1 ,$ i.e .: (water cut = 50%) [symbol]
Water tᵣₑₛ = 20 sec. A= 1/3, Rₒᵤₜ = 50 cm,
R2 (oil discharging) = 20 cm,
h = 300 cm, dr = 1 mm., \grave{ω} = 188 rad./sec.
${R}^{2} = \frac{1}{( A + 1 )} ( {R out}^{2} + {{AR}_{2}}^{2} ) \text{?}$
$R = 44.44 cm , {R}^{3} = \frac{1}{( {ρ}_{1} - {ρ}_{2} )} ( {ρ}_{1} {{R}_{1}}^{3} - {ρ}_{2} {{R}_{2}}^{3} )$ [symbol]
R1 (water discharging) = 28.8 cm. so
(Shell weight variation = 2πhρω²R² dr) Newton. will be:
(2π * 3 * 200 * (188)² * (.44)² * 0.001) = 25796 N = 2629.5 Kgs.
$\text{?} \text{indicates text missing or illegible when filed}$

This variation will create a pushing force of 2.68 tons toward stability. The physical analysis if this is that; if separated oil chamber tends to shift by 1 mm towards separated water; A total force of 2682 Kgs push oil inward and if water shift toward oil by 1 mm the same force (2682 Kgs.) push water forward. (Each mm shift of this depletion region generate a force of 2682 Kgs. That will push depletion line back. So we have a completely stable configuration.

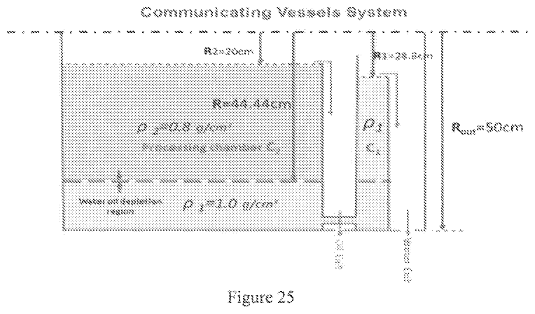

FIG. 25 illustrates an operating case study (discharging nozzle's radius). By adopting the drop velocity equation of:

$${v}_{radial} = \frac{( ρ - ρ ) {d}^{2} r {ω}^{2}}{p {18}_{μ}^{p}} m / s$$

Separation velocity v is directly related to centrifugal acceleration α=(R*(2πf)²) that is quadratically related to operating frequency. (μ denotes viscosity in Pa·sec, ρ denotes density, and α denotes the angular acceleration in rad/sec²). This illustrates the efficiency of the de-salting process.

It is noted that working on a (centrifugal acceleration) is better than working on temperature to soften or decrease μ (viscosity). The next two equations offer an explanation to why working on the centrifugal acceleration is more effective than working on the temperature to decrease the viscosity.

μ≈1/(const.+temp.), by rewriting the upper equation; we have:

$$v = ( {ρ}_{impurity} - {ρ}_{media} ) * ( const . + temp . ) * α * {( diam {.}_{impurity} )}^{2} / 18 = ( const . * α ) OR ( const . * temp . ) .$$

This shows that, using the disclosed separation system, tuning a is more efficient, faster, easier, more practical, much more economic, and quadratically related to separation speed. Further, increasing temperature is much slower, more expensive and linearly related to separation speed.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112 (f) unless the words “means for” or “step for” are explicitly used in the particular claim.

Additionally, as used herein, the phrase “at least one of [X] and [Y],” where X and Y are different components that may be included in an embodiment of the present disclosure, means that the embodiment could include component X without component Y, the embodiment could include the component Y without component X, or the embodiment could include both components X and Y. Similarly, when used with respect to three or more components, such as “at least one of [X], [Y], and [Z],” the phrase means that the embodiment could include any one of the three or more components, any combination or sub-combination of any of the components, or all of the components.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. An apparatus for processing crude oil, comprising:
a rotatable assembly, the rotatable assembly including:
a rotatable vessel having an outer wall and surrounding a volume;
a crude oil inlet to accept crude oil into the vessel;
a crude oil processing chamber to contain a volume of crude oil, the crude oil processing chamber being in fluid communication with the crude oil inlet;
a water outlet in fluid communication with the crude oil processing chamber, the water outlet being located proximate a radially outward region of the crude oil processing chamber, the water outlet configured to direct water out of the crude oil processing chamber after the water has been separated from the crude oil; and
a crude oil outlet in fluid communication with the crude oil processing chamber located at a radially inward location relative to the water outlet; and
a drive to rotate the rotatable assembly about an axis of rotation, wherein during operation of the apparatus:
the drive causes the rotatable assembly to rotate about the axis of rotation; and
crude oil in the crude oil processing chamber is caused to rotate with the rotatable assembly, causing the crude oil to separate into components of different densities, causing water to migrate toward the water outlet and oil to migrate toward the oil outlet.

2. The apparatus of claim 1, wherein the apparatus is configured to operate to continuously separate components of crude oil.

3. The apparatus of claim 1, wherein the rotatable vessel is generally cylindrical in shape, and the crude oil processing chamber is generally annular in shape, and further wherein, during operation, the crude oil separates into a radially outer annular water volume, and a radially inner oil volume.

4. The apparatus of claim 1, wherein the axis of rotation is vertically oriented, and further wherein the rotatable assembly includes at least one solids discharge port, the at least one solids discharge port being located proximal a radially outward location of the rotatable vessel proximate a bottom end of the crude oil processing chamber, wherein rotation of the rotatable assembly causes solid particulate suspended within the crude oil to migrate radially outwardly and gravity pulls the solid particulate downwardly toward the at least one solids discharge port.

5. The apparatus of claim 4, wherein the crude oil processing chamber is located in a lower portion of the rotatable vessel, and further wherein the rotatable vessel further includes a water reservoir located above the crude oil processing chamber to receive water separated in the crude oil processing chamber, wherein the water outlet is coupled to an inlet of the water reservoir by way of at least one conduit.

6. The apparatus of claim 5, wherein the water reservoir is annularly shaped.

7. The apparatus of claim 5, wherein water is advanced through the at least one conduit due to pressure exerted on the contents of the crude oil processing chamber, and further wherein the water reservoir includes at least one water outlet, wherein the at least one water outlet of the water reservoir is located in a radially inward region of the rotatable vessel.

8. The apparatus of claim 7, wherein the at least one water outlet of the water reservoir is located radially outwardly with respect to the crude oil outlet of the crude oil processing chamber.

9. The apparatus of claim 8, wherein the rotatable vessel further includes a vertically disposed gas evacuation plenum located in a central region of the rotatable vessel, wherein a radially outwardly facing surface of the gas evacuation plenum forms an inner surface of the crude oil processing chamber, and further wherein gas phases separated from the crude oil are transported upwardly through the vertically disposed gas plenum and out of the apparatus.

10. The apparatus of claim 1, further comprising a flywheel mechanically coupled to the rotatable assembly to facilitate continuous rotation of the rotatable assembly.

11. The apparatus of claim 4, wherein the at least one solids discharge port directs a slurry of material including solids into a strainer to further separate the solids from liquid components of the slurry.

12. The apparatus of claim 11, wherein the strainer includes an elongate outer vessel and an elongate porous inner vessel disposed within the elongate outer vessel, the elongate porous inner vessel having a motorized screw auger disposed therein, the strainer further having a slurry inlet to direct slurry into the elongate inner vessel, a solids outlet in mechanical communication with the elongate inner vessel, and a liquid outlet in communication with the outer vessel, wherein the slurry inlet directs slurry into the elongate inner vessel wherein the screw auger advances the slurry toward the solids outlet, and further wherein liquid is transported from the slurry and into a chamber defined between the elongate outer vessel and the elongate porous inner vessel to separate liquid from the solids in the slurry.

13. The apparatus of claim 12, wherein the strainer is inclined at an angle to cause the screw auger to advance the solids upwardly as the solids are separated from the liquid of the slurry.

14. The apparatus of claim 4, further comprising a suspended solids discharging valve in fluid communication with the at least one solids discharge port, the suspended solids discharge valve being located at least partially underneath the crude oil processing chamber.

15. The apparatus of claim 14, wherein:
the suspended solids discharging valve includes a sampling disc that defines at least one solids evacuation conduit formed therein, the sampling disc being configured to rotate relative to a lower wall of the crude oil processing chamber; and
the lower wall of the crude oil processing chamber defines at least one opening therethrough, and relative rotation of the sampling disc with respect to the lower wall of the crude oil processing chamber causes the at least one opening in the lower wall of the crude oil processing chamber to align with the at least one solids evacuation conduit of the sampling disc for a predetermined period of time to cause solids to be transported from the crude oil processing chamber, through the at least one opening in the lower wall of the crude oil processing chamber, and into the at least one solids evacuation conduit of the sampling disc.

16. The apparatus of claim 15, wherein the sampling disc is caused to rotate relative to the lower wall of the crude oil processing chamber by a gear train driven by a second drive.

17. The apparatus of claim 16, wherein the rotating assembly is configured to rotate at a first speed and the sampling disc is configured to rotate at a second speed different from the first speed in order to permit relative rotation of the sampling disc to the crude oil processing chamber.

18. The apparatus of claim 16, wherein the first speed is within about one percent of the second speed.

19. The apparatus of claim 18, wherein the first speed and second speed differ by between about one revolution per minute and about ten revolutions per minute.

20. The apparatus of claim 19, wherein the first speed is between about 500 revolutions per minute and about 5000 revolutions per minute.

21. The apparatus of claim 16, wherein the gear train is a planetary gear train.

22. The apparatus of claim 15, wherein the suspended solids discharging valve further includes a discharge ring including at least one radially outwardly facing discharge port, wherein solids are conveyed by the sampling disc to the at least one radially outwardly facing discharge port.

23. The apparatus of claim 9, further comprising an oil-gas mechanical seal disposed an upper end of the apparatus, the oil-gas mechanical seal having an interior chamber in fluid communication with an upper end of the vertically disposed gas evacuation plenum.

24. The apparatus of claim 23, wherein the vertically disposed gas evacuation plenum directs gases extracted from crude oil into a chamber of the oil-gas mechanical seal, wherein the chamber of the oil-gas mechanical seal is coupled to at least one gas exit port to transport gases out of the apparatus.

25. The apparatus of claim 24, wherein the chamber of the oil-gas mechanical seal is bounded by a peripheral wall, an upper wall and a lower wall.

26. The apparatus of claim 25, wherein the upper wall and lower wall of the oil-gas mechanical seal are each bounded by a liquid reservoir to address gas leakage from the chamber of the oil-gas mechanical seal.

27. The apparatus of claim 26, wherein the liquid reservoir comprises NaOH, wherein the gas is H₂S, and wherein the liquid reservoir addresses gas leakage by reacting with the gas to generate Na₂S.

28. The apparatus of claim 23, wherein the oil-gas mechanical seal is stationary with respect to the rotating assembly.

29. The apparatus of claim 28, wherein the oil-gas mechanical seal receives an upper portion of the rotating assembly therein that includes the upper end of the vertically disposed gas evacuation plenum.

30. The apparatus of claim 29, wherein the oil-gas mechanical seal includes a plurality of seals that seal against the upper end of the vertically disposed gas evacuation plenum.

31. A method of purifying crude oil, comprising:
directing a stream of crude oil into a rotating chamber of separation device;
causing the crude oil to rotate with the rotating chamber of the separation device to cause the crude oil to stratify along a radial direction into a gaseous component, a purified oil component, a water component, and a solids component;
causing the gaseous component to be evacuated through a gas evacuation tube in a central region of the separation device;
causing the purified oil to exit through an oil exit port located radially outwardly from the gas evacuation tube; and
causing the water component to exit through a water exit port located radially outwardly with respect to the oil exit port.

32. The method of claim 31, further comprising continuously operating the separation device and continuously introducing crude oil into the separation device and continuously evacuating oil and water from the separation device.

33. The method of claim 31, further comprising causing the solids component to be evacuated through a solids evacuation port of the separation device.

34. The method of claim 33, further comprising directing the solids component in a slurry form into a solids separation strainer.

35. The method of claim 31, further comprising directing the gaseous component into a stationary chamber of an oil-gas mechanical seal located at an upper end of the separation device, the oil-gas mechanical seal including a plurality of mechanical seals that rotatably receive the upper end of the separation device.

36. The method of claim 35, wherein the oil-gas separation device further includes liquid reservoirs located above and below the stationary chamber, wherein gas that leaks past the plurality of mechanical seals is intercepted and neutralized by the liquid reservoirs.

37. The method of claim 36, wherein the gas that leaks past the plurality of mechanical seals that is intercepted by the liquid reservoirs includes hydrogen sulfide.

38. A device to neutralize harmful gases, comprising a vessel having:
a gas receiving chamber coupled to a gas inlet and a gas outlet, the gas receiving chamber may be configured to rotatably receive a rotating tubular conduit directing a gas flow; and
liquid filled reservoirs disposed above and below the gas receiving chamber to receive gas leaking past seals of the gas receiving chamber.

38. The device of claim 37, wherein the as receiving chamber comprises a plurality of cascading chambers separated by mechanical seals.

39. The device of claim 38, wherein four cascading chambers are provided separated by four mechanical seals.

40. An oil-gas mechanical seal, the seal comprising:
an interior chamber bounded by a peripheral wall, an upper wall, and a lower wall;
a gas entrance port for allowing gas into the interior chamber, wherein the gas entrance port is in fluid communication with a gas evacuation plenum from a separator apparatus and wherein the separator apparatus has a gas exit port to transport gases out of the apparatus to the gas evacuation plenum;
wherein the upper and lower wall are bounded by a liquid reservoir that addresses gas leakage from the chamber; and
wherein the seal is stationary.

41. The oil-gas mechanical seal of claim 40, wherein the gas is H₂S, wherein the liquid reservoir is NaOH, and wherein the liquid reservoir addresses gas leakage by reacting with the H₂S to form Na₂S.
